(19) United States
(12) Patent Application Publication
(10) Pub. No.: US 2005/0225301 A1
(43) Pub. Date: Oct. 13, 2005

(54) Method and system for determining the health of a battery

(76) Inventors: Edward H. Arnold, Phoenixville, PA (US); David K. Whitmer, Center Valley, PA (US); Bruce J. Rogers, Lansdale, PA (US)

Correspondence Address: RATNERPRESTIA, P O BOX 980, VALLEY FORGE, PA, 19482-0980, US

(21) Appl. No.: 10/819,434

(22) Filed: Apr. 7, 2004

(51) Int. Cl. H02J 7/00

(52) U.S. Cl. 320/150

(57) ABSTRACT

A method of determining the health of a battery is provided. The method includes measuring at least one parameter value related to at least one of a voltage of the battery or a temperature of the battery. The method also includes comparing the measured parameter value to a corresponding predetermined parameter value. The method also includes determining the health of the battery at least partially based on a result of the comparing step.

### FIELD OF THE INVENTION

The present invention relates to batteries, and more particularly, to systems and methods for determining battery health.

### BACKGROUND OF THE INVENTION

As the use of portable powered devices increases (e.g., portable battery operated electronic devices, cordless power tools, etc.), interest in various battery technologies has also increased. In the context of rechargeable batteries, it is particularly desirable that such batteries maintain certain characteristics. For example, one such characteristic relates to the ability of a battery to repeatedly store a rated charge (i.e., to store a rated amount of power). Another such characteristic relates to the ability of a battery to accept a full charge in a rated time.

In order to determine if a battery maintains such characteristics, it is desirable to determine the health of the battery. One conventional method of determining the health of a battery is to measure an output voltage of the battery, for example, during charging. Another conventional method of determining the health of a battery is to measure a temperature of the battery, for example, during discharge. Conventional battery voltage and/or temperature displays are not accurate, however, in indicating the health of the battery. Thus, while such conventional methods may be simple, cost-effective, and convenient, they do not provide an accurate indication of a battery's health.

Another conventional method of determining the health of a battery is to measure the time it takes to discharge the battery, for example, using a discharge current specified by the battery manufacturer. Such a method typically involves completely discharging a fully charged battery using the specified discharge current. The measured (i.e., actual) discharge time is then compared to a rated discharge time, thereby providing a measure of the battery's capacity and/or heath. In certain applications, this method may be relatively dependable and accurate. This method is also very inconvenient, time consuming, and expensive.

Yet another conventional method of determining the health of a battery is known as gauging. Gauging keeps track of the energy supply to a battery, and discharged from a battery, during use. Gauging methods can therefore be used to track the behavior of a battery, and as such, provide an indication of a battery's health. Because of the moderate complexity and cost of gauging systems (e.g., gauging methods involve initial and repeated calibration, as well as periodic complete charge/discharge cycles to maintain accuracy), such systems are not practical for many products.

Thus, it would be desirable to provide methods for determining the health of batteries that overcome one or more of the above-mentioned deficiencies.

### SUMMARY OF THE INVENTION

According to an exemplary embodiment of the present invention, a method of determining the health of a battery is provided. The method includes measuring at least one parameter value related to at least one of a voltage of the battery or a temperature of the battery. The method also includes comparing the measured parameter value to a corresponding predetermined parameter value. The method also includes determining the health of the battery at least partially based on a result of the comparison of the measured parameter value to the corresponding predetermined parameter value.

According to another exemplary embodiment of the present invention, another method of determining the health of a battery is provided. The method includes measuring, during at least one of a forming phase of the battery, a charging phase of the battery, or a discharging phase of the battery, at least one parameter value related to at least one of (a) at least one of a time or a magnitude of at least one voltage slope value of the battery, or (b) at least one of a time or a magnitude of at least one temperature slope value of the battery. The method also includes comparing the measured parameter value to a corresponding predetermined parameter value. The method also includes determining the health of the battery at least partially based on a result of the comparison of the measured parameter value to the corresponding predetermined parameter value.

According to yet another exemplary embodiment of the present invention, a computer readable carrier including computer program instructions for implementing a method of determining the health of a battery is provided. The method includes measuring at least one parameter value related to at least one of a voltage of the battery or a temperature of the battery. The method also includes comparing the measured parameter value to a corresponding predetermined parameter value. The method also includes determining the health of the battery at least partially based on a result of the comparison of the measured parameter value to the corresponding predetermined parameter value.

According to yet another exemplary embodiment of the present invention, an electronic device is provided. The electronic device includes a battery that provides DC power to at least a portion of the electronic device. The electronic device also includes a computer readable carrier. The computer readable carrier includes computer program instructions for implementing a method of charging a battery. The method includes measuring at least one parameter value related to at least one of a voltage of the battery or a temperature of the battery. The method also includes comparing the measured parameter value to a corresponding predetermined parameter value. The method also includes determining the health of the battery at least partially based on a result of the comparison of the measured parameter value to the corresponding predetermined parameter value.

According to yet another exemplary embodiment of the present invention, an electronic device is provided. The electronic device includes a battery that provides DC power to at least a portion of the electronic device. The electronic device also includes a processor. The processor receives a measurement of at least one parameter value related to at least one of a voltage of the battery or a temperature of the battery. The processor compares the received measurement of the parameter value to a corresponding predetermined parameter value to determine the health of the battery.

According to yet another exemplary embodiment of the present invention, an electronic device for charging or monitoring a battery is provided. The electronic device includes a power supply that provides DC power to at least a portion of the electronic device. The electronic device also includes a processor. The processor receives a measurement of at least one parameter value related to at least one of a voltage of the battery or a temperature of the battery. The processor compares the received measurement of the parameter value to a corresponding predetermined parameter value to determine the health of the battery.

### BRIEF DESCRIPTION OF THE DRAWINGS

Exemplary embodiments of the invention will be described with reference to the drawings, of which:

FIG. 1A is a graphical profile illustrating a battery voltage trend during formation in accordance with an exemplary embodiment of the present invention;

FIG. 1B is a graphical profile illustrating a battery temperature trend during formation in accordance with an exemplary embodiment of the present invention;

FIG. 1C is a graphical profile illustrating a battery voltage slope trend during formation in accordance with an exemplary embodiment of the present invention;

FIG. 1D is a graphical profile illustrating a battery temperature slope trend during formation in accordance with an exemplary embodiment of the present invention;

FIG. 2A is a graphical profile illustrating a battery voltage trend during a charging phase in accordance with an exemplary embodiment of the present invention;

FIG. 2B is a graphical profile illustrating a battery temperature trend during a charging phase in accordance with an exemplary embodiment of the present invention;

FIG. 2C is a graphical profile illustrating a battery voltage slope trend during a charging phase in accordance with an exemplary embodiment of the present invention;

FIG. 2D is a graphical profile illustrating a battery temperature slope trend during a charging phase in accordance with an exemplary embodiment of the present invention;

FIG. 3A is a graphical profile illustrating a battery voltage trend during a discharge phase in accordance with an exemplary embodiment of the present invention;

FIG. 3B is a graphical profile illustrating a battery temperature trend during a discharge phase in accordance with an exemplary embodiment of the present invention;

FIG. 3C is a graphical profile illustrating a battery voltage slope trend during a discharge phase in accordance with an exemplary embodiment of the present invention;

FIG. 3D is a graphical profile illustrating a battery temperature slope trend during a discharge phase in accordance with an exemplary embodiment of the present invention;

FIG. 4A is a graphical profile illustrating a battery voltage trend during a charging phase for a subject battery and for a similar type of battery in accordance with an exemplary embodiment of the present invention;

FIG. 4B is another graphical profile illustrating a battery voltage slope trend during a charging phase for a subject battery and for a similar type of battery in accordance with an exemplary embodiment of the present invention;

FIG. 5A is a graphical profile illustrating a battery voltage trend during a discharging phase for a subject battery and for a similar type of battery in accordance with an exemplary embodiment of the present invention;

FIG. 5B is a graphical profile illustrating a battery temperature trend during a discharging phase for a subject battery and for a similar type of battery in accordance with an exemplary embodiment of the present invention;

FIG. 5C is a graphical profile illustrating a battery voltage slope trend during a discharging phase for a subject battery and for a similar type of battery in accordance with an exemplary embodiment of the present invention;

FIG. 5D is a graphical profile illustrating a battery temperature slope trend during a discharging phase for a subject battery and for a similar type of battery in accordance with an exemplary embodiment of the present invention;

FIG. 5E is a detail of a portion of FIG. 5C;

FIG. 5F a detail of a portion of FIG. 5D;

FIG. 6 is a flow diagram illustrating a method of determining the health of a battery in accordance with an exemplary embodiment of the present invention;

FIG. 7A is a block diagram of an electronic device in accordance with an exemplary embodiment of the present invention; and

FIG. 7B is a block diagram of another electronic device in accordance with another exemplary embodiment of the present invention.

### DETAILED DESCRIPTION OF THE INVENTION

Preferred features of embodiments of this invention will now be described with reference to the Figures. It will be appreciated that the spirit and scope of the invention is not limited to the embodiments selected for illustration. It is contemplated that any of the configurations and materials described hereafter can be modified within the scope of this invention.

U.S. Pat. No. 5,600,226 relates to battery systems and is incorporated by reference herein for its teachings related to batteries and battery charging.

As used herein, the term “battery health” or “health” refers to the ability of a battery to perform certain functions relative to predetermined values assigned to such functions for the same or a similar type of battery. For example, one such function relates to the ability of a battery to repeatedly store a rated charge, and another such function relates to the ability of a battery to accept a full charge in a rated time.

As used herein, the term “health rating” is a measure assigned to a battery based at least partially upon a comparison of measured characteristics of a subject battery to predetermined characteristics of the same or a similar type of battery. For example, a ratio of the measured characteristic (e.g., the time to reach a minimum voltage slope value) to the predetermined characteristic value may be a health rating. Such a health rating may be expressed in a number of alternative formats.

As used herein, the expression “alerting a user” as to a health rating refers to any of a number of methods of alerting a user as to an assigned health rating of a battery. For example, a user may be alerted as to such a health rating using an indicator of percent health of the battery, a block indicator of the health of a battery, etc. The indicators may be visual (e.g., displays), audible, or a combination of the two. Other types of indicators may also be used as may be beneficial for a particular application (i.e., tactile or temperature).

As used herein the term “formation” refers to the process of forming a battery where an initial charge is applied to a battery, and typically, a full charge is applied to the battery (e.g., factory charging and discharging). The term “charge” or “charging” refers to a process of applying electrical energy to a battery such that the battery may convert the applied energy to stored energy within the battery. The charge may be a full or partial charge. Likewise, the term “discharge” or “discharging” refers to a process of withdrawing electrical energy from a battery, for example, by supplying the withdrawn electrical energy to a load. The discharge may be a full or partial discharge.

As used herein, the phrase “parameter value” or “actual parameter value” refers to a value of a parameter (e.g., voltage magnitude, timing of a voltage value, voltage slope magnitude, timing of a voltage slope value, temperature magnitude, timing of a temperature value, temperature slope magnitude, timing of a temperature slope value) used in determining the health of a battery. More specifically, in various exemplary embodiments of the present invention, at least one parameter value is measured. The parameter(s) relates to either or both of the voltage and temperature of a battery. For example, if the parameter relates to battery voltage, the parameter value may be the magnitude of the actual voltage of the battery, the timing of a voltage value/event, the magnitude of the voltage slope, or the timing of a voltage slope value/event. Likewise, if the parameter relates to battery temperature, the parameter value may be the magnitude of the actual temperature of the battery, the timing of a temperature value/event, the magnitude of the temperature slope, or the timing of a temperature slope value/event. This measured parameter (or parameter value) is compared to a predetermined parameter value in order to determine the health of a battery.

As used herein, the term “predetermined parameter value” or “corresponding predetermined parameter value” refers to the value of the parameter that the actual parameter value is compared with in order to determine the health of a battery. Thus, the predetermined parameter value relates to the same parameter as the actual parameter value. Thus, if the actual parameter relates to voltage (e.g., the magnitude of the voltage slope or the timing of a voltage slope value/event) then the predetermined parameter value also relates to voltage. The predetermined parameter value may be predetermined by, for example, studying batteries, experimenting with battery characteristics, determining/calculating ideal or theoretical values, etc. Further, the predetermined parameter value may actually be derived or measured from testing on the subject battery (e.g., prior testing on the subject battery gave rise to the predetermined parameter value). The predetermined parameter value may then be stored in memory (e.g., a database, a look-up table, etc.) for future use as a baseline for comparison with actual parameter values to determine the health of the actual battery.

According to certain exemplary embodiments, the present invention determines the health of a battery by measuring at least one parameter value related to at least one of the voltage or temperature of the battery (e.g., during at least one of formation, charging, or discharging of the battery), and comparing the measured parameter value(s) to corresponding predetermined parameter values established for the same or a similar type of battery (e.g., a healthy battery). In certain embodiments of the present invention, the actual measured parameter value is the voltage or temperature (i.e., the magnitude), which is then compared to the corresponding predetermined parameter value to determine the health of the battery. In other embodiments, measured timing (i.e., occurrence in time) of an actual voltage or temperature event (e.g., the timing of a threshold voltage being crossed) is compared to the corresponding predetermined parameter value to determine the health of the battery. In still other embodiments, both the actual magnitude and timing of a voltage and/or temperature may be compared to the corresponding predetermined parameter values to determine the health of the battery.

As described in greater detail below, certain exemplary embodiments of the present invention measure/calculate a slope of at least one of the voltage or temperature of the battery (e.g., using multiple voltage or temperature measurements), and compare the measured slope value to the corresponding predetermined slope parameter value established for the same or a similar type of battery.

More specifically, certain exemplary embodiments of the present invention involve determining the health of a battery using knowledge of one or more occurrences of either or both of (a) a voltage slope parameter value of a battery (e.g., a voltage slope minimum, a voltage slope maximum, etc), and (b) a temperature slope parameter values of a battery (e.g., a temperature slope minimum, a temperature slope maximum). The slope parameter value(s) (i.e., voltage slope and temperature slope) of the subject battery are compared to a corresponding predetermined slope parameter value(s) established for the same or similar types of batteries.

Certain of the battery health determination methods disclosed herein provide real time comparisons of the actual battery parameter values to corresponding predetermined parameter values established for the same or a similar type of battery, for the same or a similar energy input process (e.g., formation, charging) or for the same or similar energy removal process (e.g., discharging). Such real time comparisons may be conducted during the actual formation, charging, and/or discharge phases, thereby substantially eliminating the need for any special health determination process that occurs distinct from the regular processes (forming, charging, and/or discharging).

Battery voltage slope is defined as the rate at which the voltage of a battery changes with respect to time (i.e., the first derivative of battery voltage with respect to time). Likewise, battery temperature slope is defined as the rate at which the temperature of a battery changes (i.e., the first derivative of battery temperature with respect to time). The slope of either of the voltage or temperature may be positive, zero, or negative.

For example, if the numeric value for voltage slope is positive, the voltage is increasing. If the numeric value for voltage slope is zero, the voltage is constant, and if the numeric value for voltage slope is negative, the voltage is decreasing. Similarly, if the numeric value for temperature slope is positive, the temperature is increasing. If the numeric value for temperature slope is zero, the temperature is constant, and if the numeric value for temperature slope is negative, the temperature is decreasing.

According to the present invention, a plurality of milestone points that occur during each of battery formation, charging, and/or discharging processes are identified. For example, minimum and/or maximum voltage slope and/or temperature slope values may be used as accurate and dependable milestone points in determining the health or condition of a battery. Typically, such values occur when there is minimal change in the underlying parameter (e.g., voltage or temperature), and as such, these points provide stable, accurate, predictable, and repeatable battery health determination points.

Exemplary embodiments of the present invention may use one or more of a plurality of measured, actual parameter values in determining the health of a battery. For example, a given profile (e.g., a voltage slope profile) may have a plurality of slope minimums (e.g., voltage slope minimums). A single occurrence of a single voltage slope minimum may be compared to a corresponding predetermined voltage slope minimum established for the same or a similar type of battery to determine the battery health. Alternatively, a plurality of voltage slope minimums may be compared to a corresponding plurality of predetermined voltage slope minimums to determine the battery health.

According to certain exemplary embodiments of the present invention, points of minimal change in a voltage and/or temperature profile of a battery (e.g., points of minimum slope) that occur, for example, during formation, charging, and/or discharging, provide for an accurate, repeatable determination of the health/condition of a battery with little or no additional cost. This is because components that are already part of an existing formation system, charging system, and/or discharging system may be utilized. In such embodiments, minimal additional components (e.g., a resistive circuit for measuring discharge current, a sensor for measuring ambient temperature changes, etc.) may be used.

As provided above, the measurement of the actual parameter values may occur, for example, during at least one of a formation phase, charging phase, or discharging phase of a battery. During formation and charging processes, electrical energy is applied to a battery, for example, using a fixed and/or variable current, voltage, and/or power sources to define a specific electrical energy input process. The timing and/or magnitude of slope parameter values (e.g., minimum/maximum voltage slopes, minimum/maximum temperature slopes) for batteries of a certain type and rating may be established (i.e., predetermined) using a specific electrical energy input process (i.e., formation and/or charging). During such an electrical energy input process for an actual subject battery, the timing and/or magnitude of corresponding slope values may be measured, and thereafter compared to the corresponding predetermined slope parameter values to determine the health of the subject battery.

Similarly, in relation to a battery discharging process, electrical energy is removed from the battery, for example, using a fixed and/or variable current, power, and/or resistive loads, thereby establishing a specific electrical energy removal process. The timing and/or magnitude of actual slope parameter values (e.g., minimum/maximum voltage slopes, minimum/maximum temperature slopes) for batteries of a specific type and rating may be established (i.e., predetermined) using the specific electrical energy removal process. During such an electrical energy removal process for an actual subject battery, the timing and/or magnitude of corresponding slope parameter values may be measured, and thereafter compared to the predetermined slope parameter values to determine the health of the subject battery.

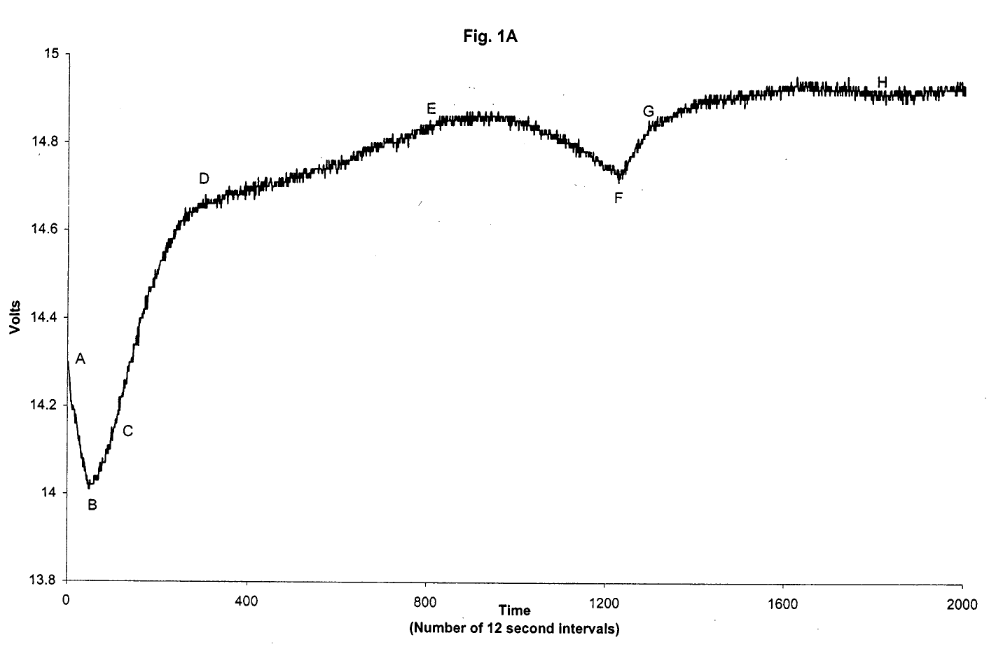

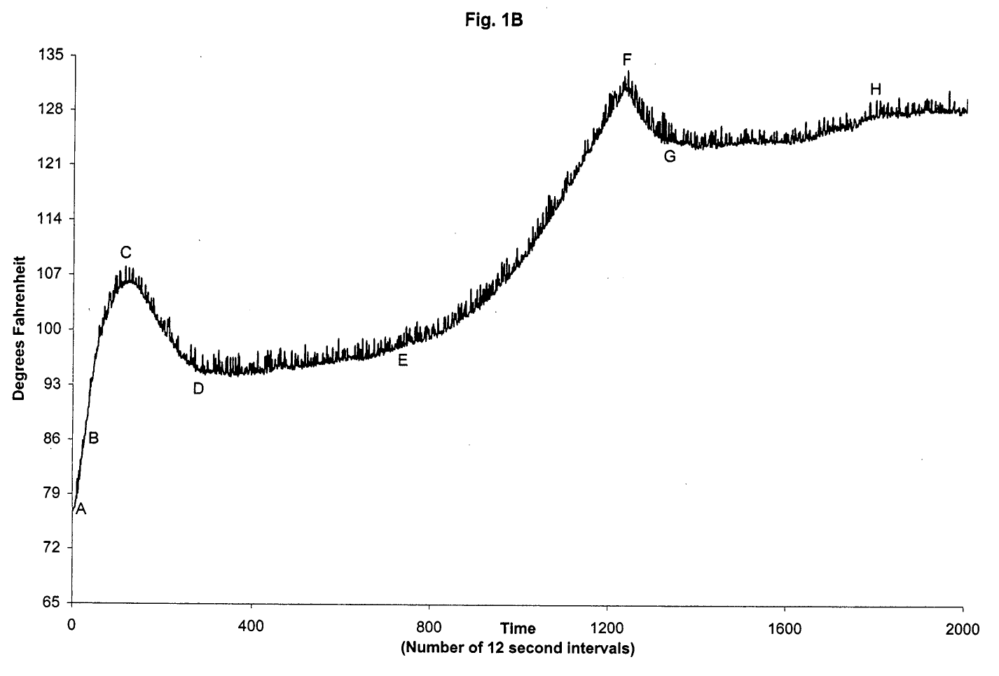

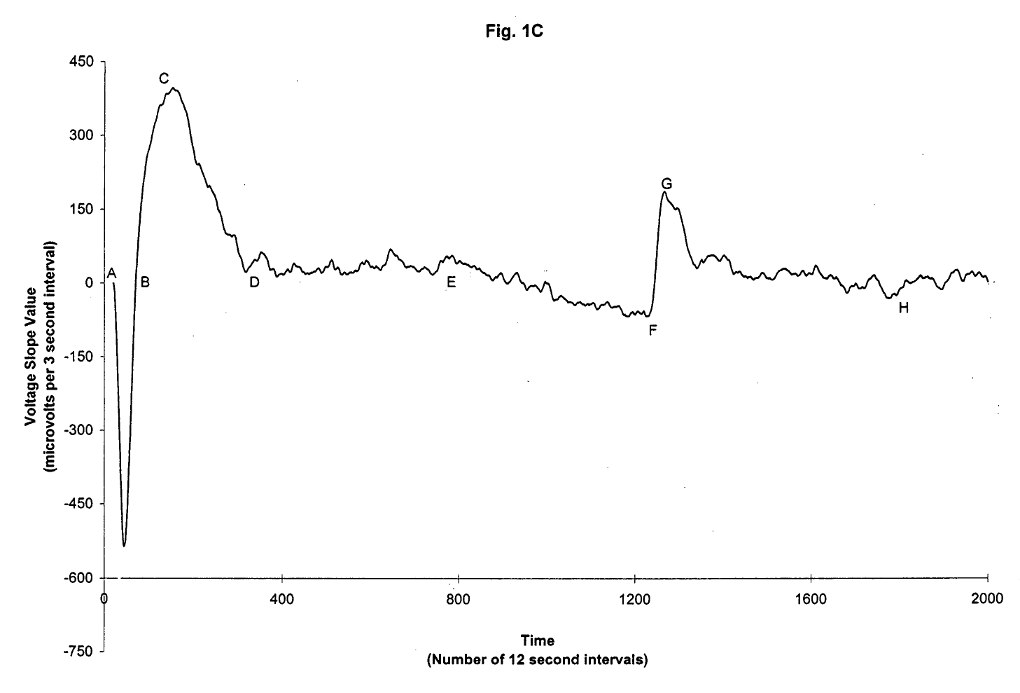

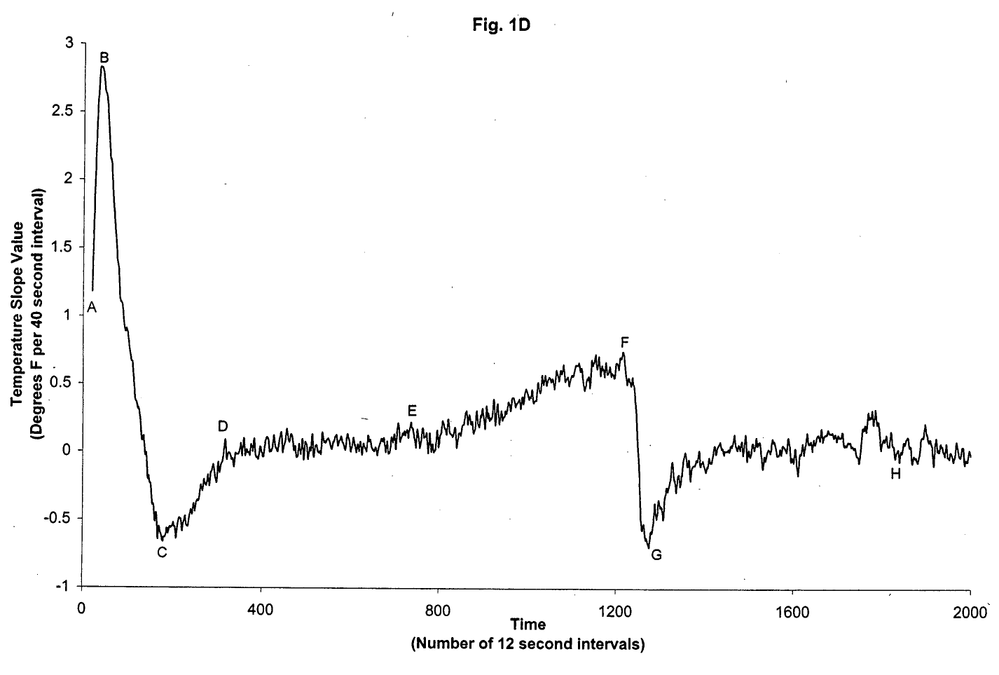

FIG. 1A is a graph illustrating an exemplary battery voltage trend during formation, while FIG. 1C is a graph illustrating a battery voltage slope trend corresponding to the trend illustrated in FIG. 1A. More specifically, FIG. 1C represents the derivative of the trend illustrated in FIG. 1A. FIG. 1B is a graph illustrating an exemplary battery temperature trend during formation, while FIG. 1D is a graph illustrating a battery temperature slope trend corresponding to the trend illustrated in FIG. 1B. More specifically, FIG. 1D represents the derivative of the trend illustrated in FIG. 1B. A number of points (i.e., points A-H) are illustrated on FIGS. 1A through and 1D. Point A on FIG. 1A corresponds to the same point in time as point A on FIGS. 1B-D. This is also true for points B-H.

Referring again to FIG. 1A, the vertical axis is expressed in volts, and the horizontal axis is expressed in units of time (i.e., the intervals) where each unit equals approximately 12 seconds. The illustrated voltage and time ranges and units are exemplary. For various battery chemistries (e.g., Nickel Cadmium, Nickel Metal Hydride, Nickel Zinc, Lead Acid, Lithium Ion, Lithium Polymer) the battery voltage normally rises instantly at the initiation of the formation process in response to the application of electrical energy. Point A of FIG. 1A illustrates that the voltage at the start of formation is approximately 14.3 volts. Shortly after initiating the input of electrical energy to the battery, the battery voltage declines because the formation source is energy limited as illustrated at point B in FIG. 1A. For example, this battery voltage decrease may be particularly observable when the input energy supply is a current limited supply.

The rate at which the battery voltage decreases with respect to time (e.g., voltage slope) varies depending on, for example, the battery type, the relative health/condition of the battery, and the amount of energy supplied to the battery. In FIG. 1A, the voltage decreases from approximately 14.3 volts at point A to approximately 14 volts at point B. This decrease in voltage results in a minimum voltage slope value (illustrated in FIG. 1C) between point A and B. This minimum slope value that occurs during formation has a voltage magnitude value of approximately −520 volts (See the vertical axis in FIG. 1C) and a timing value of approximately 50 time intervals (See the horizontal axis in FIG. 1C).

As the formation process illustrated by the voltage trend of FIG. 1A progresses further past point B, the battery voltage begins rising again. At point C illustrated in FIG. 1A, the corresponding rate of rise of the battery voltage produces a maximum voltage slope value (See point C in FIG. 1C).

Point D illustrated in FIGS. 1A and 1C is a reference point that occurs before a second voltage slope minimum value occurs at point F. For example, this second voltage slope minimum value occurs for certain battery technologies (e.g., Nickel Cadmium, Nickel Metal Hydride, and certain Lead Acid batteries) with the formation energy input source in a current limited mode. For other battery technologies (e.g., Lithium Ion, Lithium Polymer) this second voltage slope minimum may be a zero slope value that occurs because the formation energy source is a voltage limited source. For such exemplary battery technologies (e.g., Lithium Ion, Lithium Polymer), the formation process is substantially concluded beyond point E as the battery voltage is constant and the slope minimum is substantially zero as the formation energy source remains voltage limited until the end of the formation process.

Points F, G, and H on FIGS. 1A-1D are provided as exemplary parameter values that may occur during the formation process. For example, point F could be the occurrence of a maximum temperature parameter value (See FIG. 1B). In such an example, points G and H result from a cooling process that is activated to conclude the formation process.

As provided above, according to certain exemplary embodiments of the present invention, the health of a battery may be determined by comparing certain measured parameter values of a subject battery (e.g., voltage minimums/maximums) to corresponding predetermined parameter values for the same or a similar type of battery. Referring again to FIG. 1A, exemplary voltage minimum parameter values occur at points B and F. These voltage minimum parameter values represent a certain magnitude of voltage, and these voltage minimums occur at a certain point in time. The voltage minimum parameter values (i.e., the magnitude and/or occurrence in time) can be compared to predetermined parameter values established for the same or a similar type of battery to determine the health of a battery.

For example, the actual magnitude of each voltage minimum parameter value may be compared to a corresponding predetermined magnitude of a corresponding voltage minimum parameter value. The ratio of the actual magnitude to the predetermined magnitude may be used (e.g., in conjunction with a database, a look-up table, etc.) to assign a health rating to the battery. It has been found that in certain embodiments of the present invention, more accurate health ratings may be determined by comparing the actual voltage slope minimum parameter values (as opposed to the actual voltage minimum parameter values) to predetermined voltage slope minimum parameter values for the same or a similar type of battery.

For example, referring again to FIG. 1C, according to an exemplary embodiment of the present invention, the health of a battery (e.g., during formation) may be determined using one or more voltage slope minimum parameter values (e.g., the voltage slope minimum between points A and B, and the voltage slope minimum at point F, both illustrated in FIG. 1C). More specifically, according to an exemplary health determination, the health of a battery may be determined by comparing both (a) the actual time to the first voltage slope minimum parameter value and (b) the actual time to the second voltage slope minimum parameter value with corresponding predetermined times established for the first and second voltage slope minimum parameter values for the same or a similar type of battery (e.g., a normal, healthy battery). Even more specifically, the health of a battery may be determined by creating two actual to predetermined (i.e., baseline) time ratios: a first time ratio representing a comparison of a first actual voltage slope minimum parameter value with a corresponding predetermined first voltage slope minimum parameter value, and a second time ratio representing a comparison of a second actual voltage slope minimum parameter value with a corresponding predetermined second voltage slope minimum parameter value. These two ratios can be used independently or in combination to determine the health of the battery. For example, if the ratios are combined, the health of the battery may be expressed in terms of a percentage of a baseline or as a decimal expression.

In certain embodiments of the present invention the health of a battery may be established using a single voltage slope minimum parameter value (e.g., the first voltage slope minimum during formation). Based on the health of the battery established using the single voltage slope minimum parameter value, the control of the remainder of the current process (e.g., formation, charging, or discharging) may be changed. For example, in the case of a health determination made during formation (e.g., using the first voltage slope minimum occurring during formation), the formation process may be continued, terminated, delayed, or otherwise varied based on the determined health of the battery using the single voltage (or temperature) slope parameter value.

In such an example, the health of a partially formed battery is determined by comparing the actual time to the first voltage slope minimum parameter value to a corresponding predetermined (e.g., normal) time established to the first voltage slope minimum parameter value. The health of the partially formed battery may be expressed by creating an actual to normal time ratio related to the first voltage slope minimum parameter value.

As provided above, FIG. 1B is a graph illustrating an exemplary battery temperature trend during formation. The change of temperature with respect to time (e.g., temperature slope) varies during formation, for example, based on the health/condition of the battery and the amount of energy input to the battery. As shown in FIG. 1B, at the initiation of the formation process, battery temperature rises in response to the application of electrical energy. This is because the temperature of an unformed (or minimally formed) battery rises in response to input energy, and is particularly observable when the input energy that is provided is from a current limited energy source. As the formation process progresses, the rate at which the temperature of the battery increases in response to the application of electrical energy decreases (i.e., the temperature slope becomes less positive, as illustrated following point B in FIG. 1D). At a certain point in time the battery temperature slope reaches a minimum value. Such a temperature slope minimum may still be positive (i.e., the temperature is still increasing, but at a reduced rate), zero (i.e., representing a constant temperature), or negative (i.e., representing a declining battery temperature).

Regarding the temperature slope minimum, certain battery technologies (e.g., Lithium Ion, Lithium Polymer) reach this point because the formation energy source is a voltage limited energy source, and as such, formation current decreases from a preset limit. Regarding such battery technologies, the present invention may be used to determine battery health by using the occurrence of the temperature slope minimum of the battery during the current limited phase of formation.

In an embodiment where it is desired to determine the health of a subject Lithium-type battery, an actual temperature slope minimum parameter value may be compared to a predetermined temperature slope minimum parameter value that has been established for the same or a similar type of Lithium battery that is healthy. More specifically, the health of the formed Lithium battery may be determined by creating an actual to predetermined temperature slope ratio. Such a ratio may be, for example, a ratio of the actual time to the actual temperature slope minimum to the predetermined time to the predetermined temperature slope minimum. Alternatively, such a ratio may be a ratio of the actual temperature at the temperature slope minimum to the predetermined temperature at the temperature slope minimum.

Other battery chemistries (e.g., Nickel Cadmium, Nickel Metal Hydride, and certain Lead Acid batteries) also achieve temperature slope minimums during formation. As described above, such temperature slope minimums may be positive, zero (i.e., representing a constant temperature), or negative (i.e., representing a declining battery temperature).

Referring again to FIG. 1B, as the formation process progresses further, the battery temperature begins rising again (from point D to point F) resulting in a positive value for the temperature slope value (See FIG. 1D). Further still, as the formation process progresses even further, the rate at which the battery temperature rises may decrease, thereby resulting in a smaller positive value for the temperature slope (i.e., another temperature slope minimum). In some formation processes, the battery temperature may once again stop increasing and remain constant (i.e., resulting in a temperature slope value that is essentially zero), thereafter producing a positive temperature slope value as the battery temperature rises.

According to certain embodiments of the present invention, the health of the battery (a completely formed battery) may be determined using the occurrence of two temperature slope minimum parameter values of the battery. For example, the health may be determined by comparing both (a) the actual time to the first temperature slope minimum and (b) the actual time to the second temperature slope minimum to the predetermined times established to the first and second temperature slope minimums (e.g., the times to the first and second temperature slope minimums for a normal healthy battery).

As described above, the health of the battery (e.g., a newly formed battery) may be determined by creating actual to predetermined time ratios. One such ratio may relate to the occurrence of the first temperature slope minimum compared to the occurrence of the predetermined first temperature slope minimum, while another such ratio may relate to the occurrence of the second temperature slope minimum compared to the occurrence of the predetermined second temperature minimum. These two ratios may be used independently, or in combination, to establish battery health.

Alternatively, the health of a battery (e.g., in partial formation) may be determined using the occurrence of the first temperature slope minimum of the battery. By determining the health of the battery during formation, the remainder of the formation process may be controlled (e.g., continued, stopped, or otherwise varied) at least partially based on the determined health.

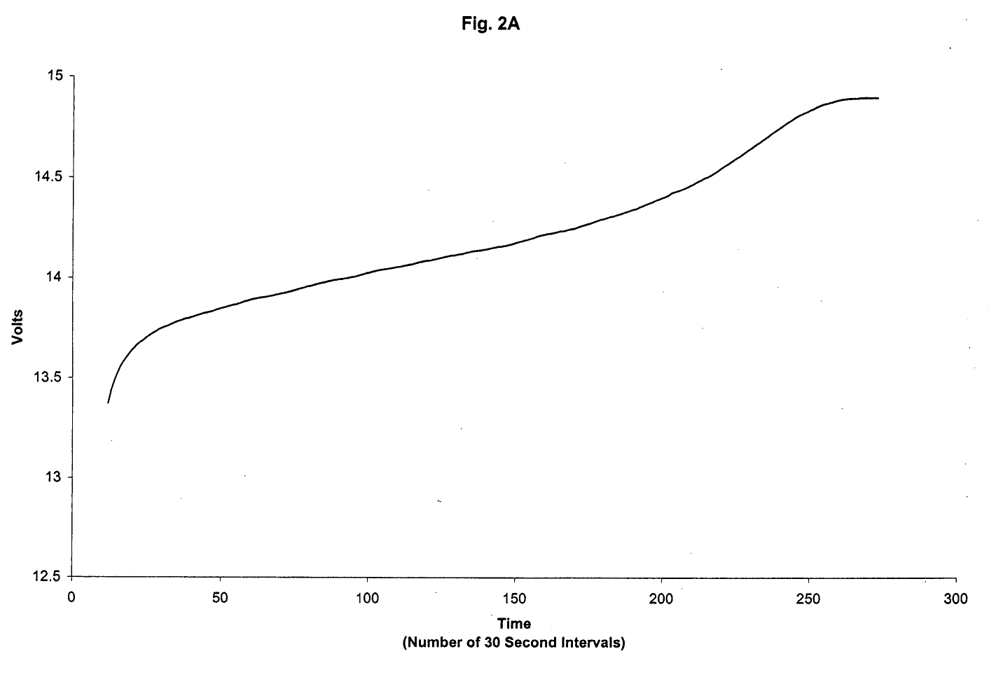

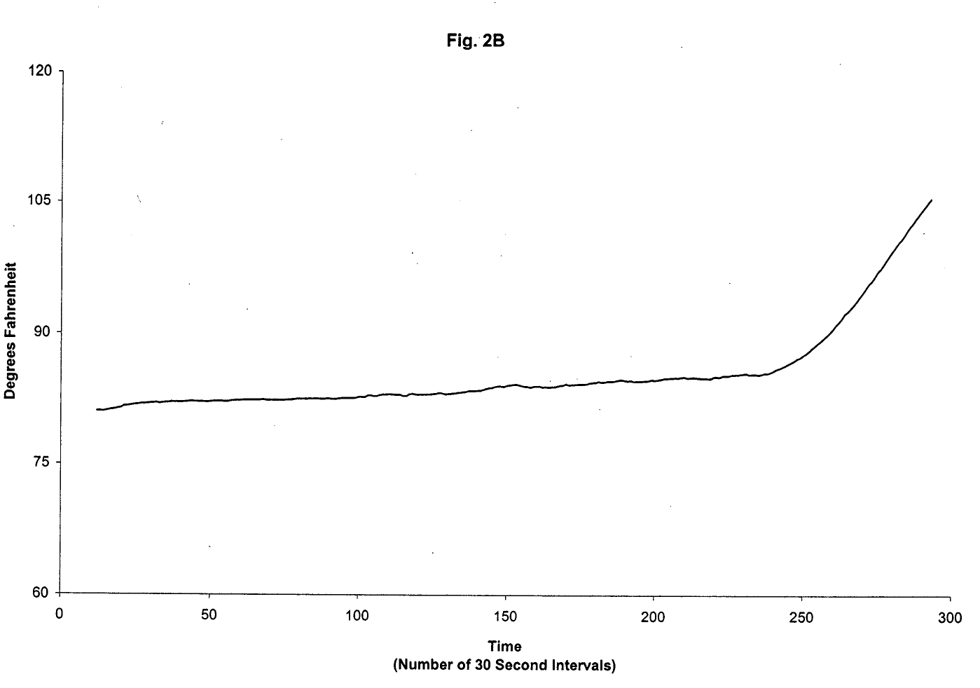

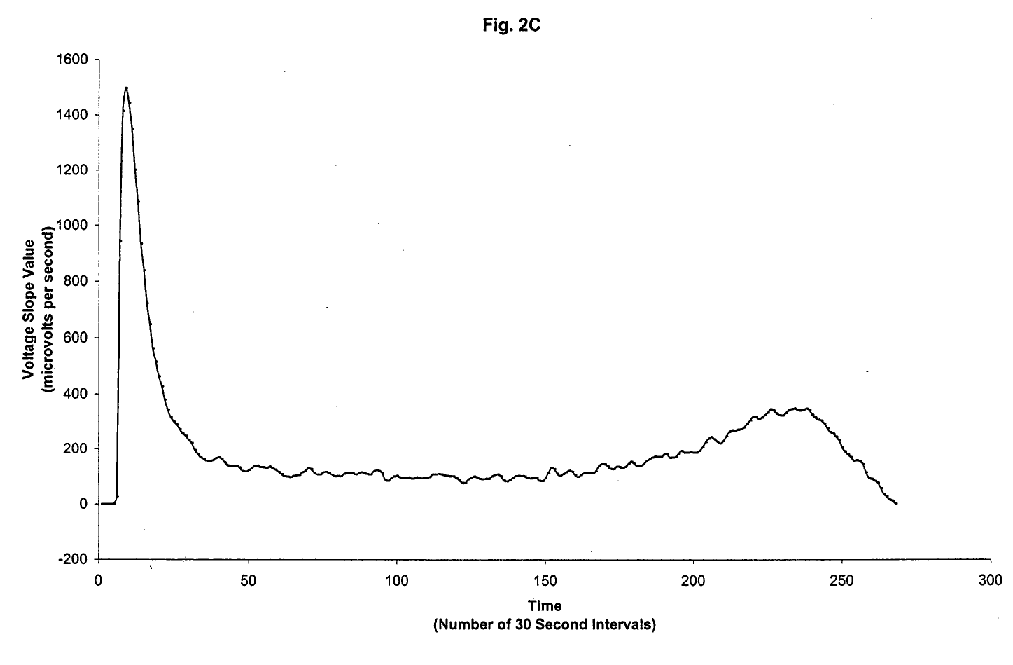

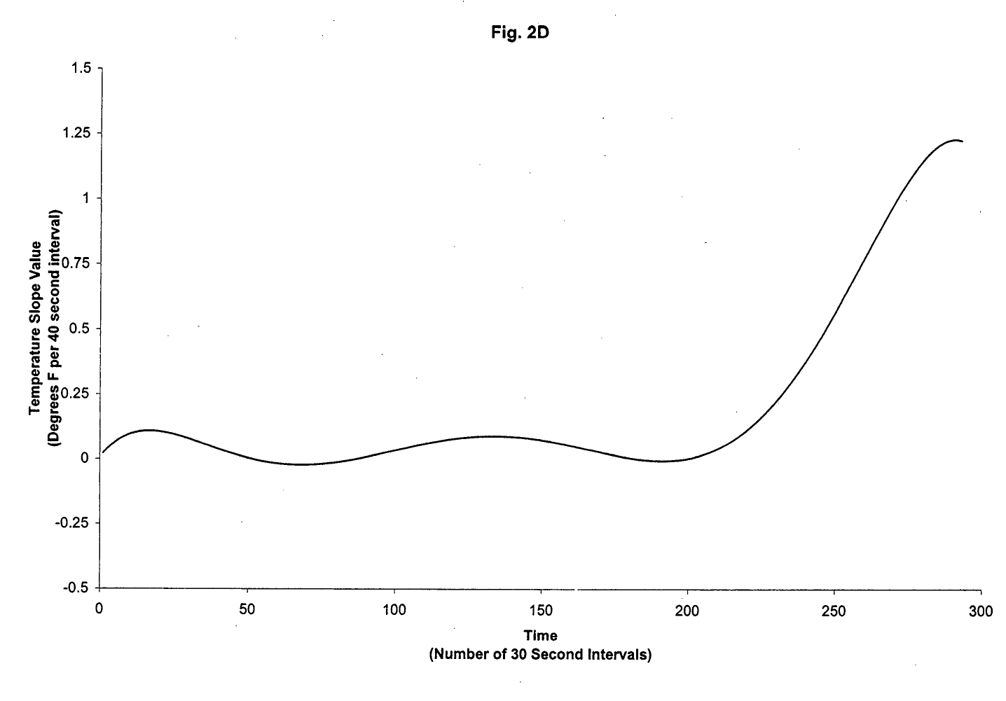

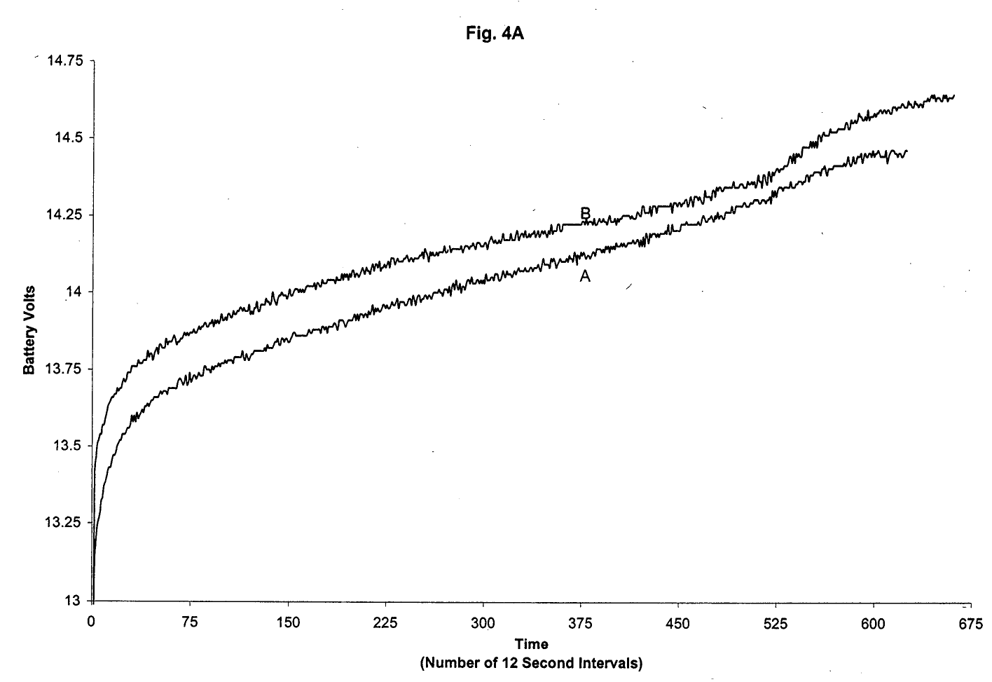

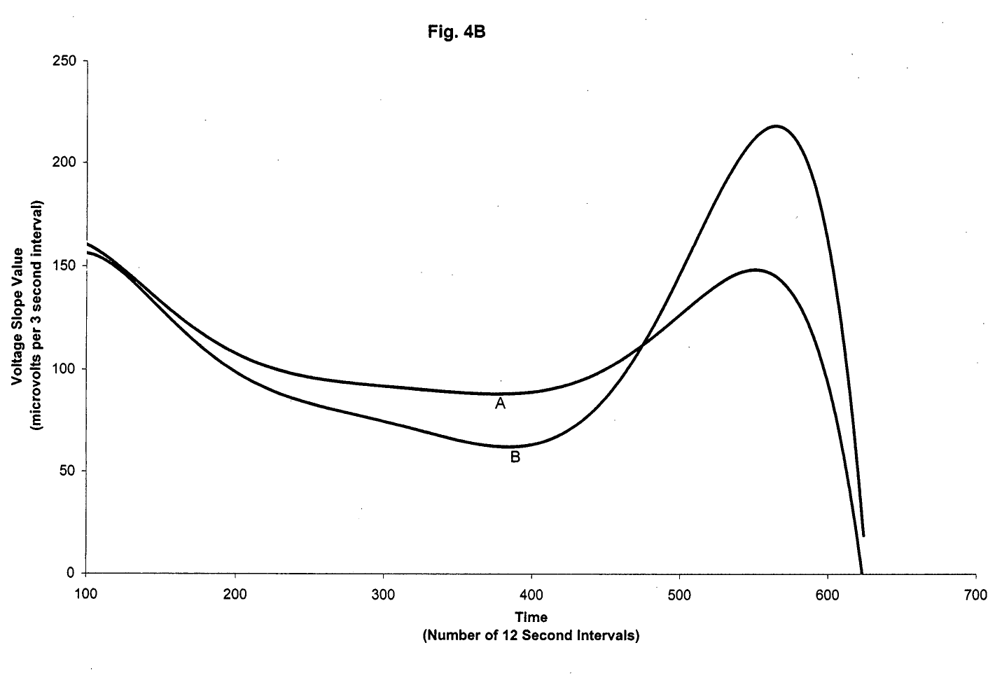

FIG. 2A is a graph illustrating an exemplary battery voltage trend during a charging phase, while FIG. 2C is a graph illustrating a battery voltage slope trend corresponding to the trend illustrated in FIG. 2A. More specifically, FIG. 2C represents the derivative of the trend illustrated in FIG. 2A. FIG. 2B is a graph illustrating an exemplary battery temperature trend during a charging phase, while FIG. 2D is a graph illustrating a battery temperature slope trend corresponding to the trend illustrated in FIG. 2B. More specifically, FIG. 2D represents the derivative of the trend illustrated in FIG. 2B. FIGS. 2A-2D using 30 second time intervals on the horizontal axes. Although FIGS. 2A-2D are not labeled with points (e.g., points A-H) as are FIGS. 1A-1D, an example of a health determination in a charging process using such points is provided below with respect to FIGS. 4A-4B.

When a typical, completely formed battery is charged, the voltage normally rises in response to electrical energy input (i.e., the applied charge). The rate at which the voltage of the battery rises with respect to time (e.g., the voltage slope) varies depending on, for example, the type of battery and the relative health/condition of the battery. Various commercially available battery technologies (e.g., Nickel Metal Hydride, Nickel Zinc, Lithium Ion, Lithium Polymer, Lead Acid, Chargeable Alkaline, etc.) exhibit a rise in temperature throughout the charging phase because the basic charging reaction is exothermic (e.g. generates heat). Certain battery types (e.g., Nickel Cadmium), however, do not exhibit such characteristics.

For moderate charge rates (1-hour or longer), empty Nickel Cadmium batteries exhibit a small drop in temperature as the basic charging reaction is slightly endothermic (e.g., absorbs heat) from the beginning of the charging process to slightly beyond the half-way point of the charging cycle. During the latter half of the charging cycle, when the efficiency of the Nickel Cadmium charge reaction decreases, the charging process becomes exothermic, thereby producing a temperature rise.

As provided above, the rate at which the voltage of a battery rises with respect to time (e.g., voltage slope) typically varies depending upon, for example, the health/condition of the battery, as well as the amount of energy applied to the battery. This rate of change is particularly observable when the input energy supply is from a current limited source. As the charging process progresses, the rate at which the battery voltage rises in response to the application of electrical energy provides a voltage slope value that is less positive as time progresses. Eventually the battery voltage increases at a minimal rate resulting in a minimum value for voltage slope. As the charging process progresses even further, the battery voltage typically begins to rise again, resulting in a more positive voltage slope.

For certain battery technologies (e.g., Nickel Cadmium, Nickel Metal Hydride), the rate at which the battery voltage rises slows yet again, resulting in a voltage slope value that becomes less positive as time progresses. For such batteries, a charging phase applied according to U.S. Pat. No. 5,600,226, may result in an end to the charging phase while the voltage slope value is positive as in FIGS. 4A and 4B.

FIGS. 4A and 4B are battery voltage and battery voltage slope trends (using 12 second time intervals on the horizontal axes), respectively, that are useful in describing an exemplary method of determining the health of a battery. The subject battery is a 3.5 ampere-hour, 10 cell (i.e., 12V), Nickel Metal Hydride battery, that may be charged, for example, according to the methods described in U.S. Pat. No. 5,600,226. The charge current applied for this exemplary battery is 1.75 amperes, which typically provides a complete charge in approximately 2 hours (i.e., ideally 1.75 amperes times 2 hours equals 3.50 ampere hours). Interestingly, the normal charge time for a normal healthy battery of this type is 1.75 amperes times 2.2 hours or 3.85 ampere-hours, because the charging process in this example is 90% efficient.

Exemplary actual voltage and voltage slope minimum parameter values during the charging phase of the subject battery are illustrated at point A in FIGS. 4A and 4B. The corresponding predetermined voltage and voltage slope parameter values (e.g., for a normal healthy battery) during the charging phase of the same or a similar type of battery are illustrated at point B in FIGS. 4A and 4B. In the example described herein with reference to FIGS. 4A-4B, the occurrence (i.e., timing) and magnitude of point A in FIG. 4B for the subject battery is compared with the predetermined occurrence (i.e., timing) and magnitude of point B in FIG. 4B to determine the health of the subject battery.

More specifically, a first ratio is calculated by dividing the timing of point A in FIG. 4B (i.e., approximately 378 on the horizontal axis) by the timing of point B in FIG. 4B (i.e., approximately 384 on the horizontal axis) is:
Ratio 1=378/384=0.9844

In this example, the occurrence of point A in FIG. 4B (approximately 378 on the horizontal axis) is at the 378^{th} 12-second interval from the start of the charging process. Thus, the occurrence of point A in FIG. 4B is at approximately 378×12 or 4536 seconds (i.e., approximately 75.6 minutes or 1.26 hours) from the start of the charging process. Similarly, the occurrence of point B in FIG. 4B (approximately 384 on the horizontal axis) is at the 384^{th} 12-second interval from the start of the charging process. Thus, the occurrence of point B in FIG. 4B is at approximately 384×12 or 4608 seconds (i.e., approximately 76.8 minutes or 1.28 hours) from the start of the charging process.

The health of this battery could be determined using this ratio alone, where the health rating would be 0.9844 or 98.44%. In this example, a second ratio is used in conjunction with the first ratio to provide a more accurate battery health determination.

The second ratio is calculated using the magnitude of point A in FIG. 4B (i.e., approximately 88 on the vertical axis) and the magnitude of point B in FIG. 4B (i.e., approximately 64 on the vertical axis) in the following exemplary formula:
Ratio 2=[7920−(9×88)]/[7920−(9×64)]=7128/7344=0.9706

In this example, 7920 is the number of seconds in 2.2 hours, which is a typical interval used to completely charge an empty normal healthy battery of this type. A factor is also used in this calculation (e.g., 9) which has been established in the characterization of a normal healthy battery of this type.

In this example, the health of the subject battery, expressed in decimal form (desired=1.000), is the product of above two ratios:
Health Rating, decimal=0.9844×0.9706=0.9555

The health of the subject battery expressed in percent form (desired=100%) is:
Health Rating, percent=(0.9555×0.9706)×100%=95.55%

Such a health rating (95.5%) may be an indication that the subject battery is healthy, depending upon a threshold value established beyond which a battery is determined to be healthy. As provided above, a desired health rating may be 100%. Certain batteries may actually be determined to have a health rating greater than 100% in certain situations.

In this example, the voltage slope minimum parameter values of FIG. 4B (point A and point B) result from a charging method selected from the charging methods disclosed in U.S. Pat. No. 5,600,226, and a data acquisition method disclosed therein where a count difference of voltage slope of 100 equals 100 μV per 3 second change in battery voltage (approximately 33.3 microvolts per second). In this example, point B in FIG. 4B (i.e., 64 on the vertical axis) represents a predetermined battery voltage change of 33.3 μV/s×64/100, or a 21.3 μV/s minimum voltage slope value. Similarly, point A in FIG. 4B (i.e., 88 on the vertical axis) for the subject battery is a 33.3 μV/s×88/100, or 29.3 μV/s minimum voltage slope value.

For certain battery technologies (e.g., Nickel Cadmium, Nickel Metal Hydride), as a charging process continues the voltage slope value may decrease, while still being positive. In such technologies, the decrease in voltage slope results in another (e.g., a second) voltage slope minimum value, for example, that may be substantially equal to the first voltage slope minimum value. The second voltage slope minimum value may occur even if the charging source supplies a constant current. In these technologies, exemplary embodiments of the present invention may determine the health/condition of a battery using the magnitude and/or timing of either or both of the voltage slope minimums. For example, an initial health of the battery may be determined after measuring a first minimum voltage slope parameter value while the charging phase is still in progress. In such an embodiment, a follow up health determination may be made (e.g., a ratio of the actual time to a predetermined time for the occurrence of the second minimum voltage slope parameter value). Further, the health of the battery may be determined using both health parameters (i.e., a health determination based on each of a first minimum voltage slope parameter value and a second voltage slope parameter value).

In certain battery technologies (e.g., Lithium Ion, Lithium Polymer, certain Lead Acid batteries), a second voltage slope minimum occurs because the charging source is voltage limited. As with the batteries described above, the health of such a battery may be determined using one or both of the two voltage slope minimum parameter values.

During a charging process, the rate at which the temperature of a battery changes with respect to time (e.g., temperature slope) varies during the charging process depending on, for example, the health/condition of the battery, and the amount of energy in the battery. At the initiation of the charging process, the battery temperature typically rises slowly in response to the application of electrical energy (See, e.g., FIG. 2A). Such a rise in temperature in response to input energy may be particularly observable when the input energy is provided by a current limited source. As the charging process progresses, the rate at which the battery temperature increases in response to the application of electrical energy decreases, thereby resulting in a temperature slope value that eventually becomes less positive as time progresses. At a point in time, the battery temperature slope reaches a minimum value which may be used as a parameter value for determining the health of the battery.

Certain battery technologies (e.g., Lithium Ion, Lithium Polymer, Nickel Zinc, and certain Lead Acid batteries) reach such a minimum temperature slope value at least partially because the charging energy source is a voltage limited source, and as such, charging current decreases from its preset limit. According to certain exemplary embodiments of the present invention, the health/condition of such batteries may be determined using the magnitude and/or timing of a temperature slope minimum of the battery during the current limited phase of charge. For example, the health/condition of the battery may be determined by comparing an actual minimum temperature slope parameter value to a corresponding predetermined minimum temperature slope parameter value established for a normal, healthy battery that is of the same or a similar type.

As the charging process progresses with a limited charging current source, the rate at which the battery temperature increases in certain battery technologies (e.g., Lithium Ion, Lithium Polymer, Nickel Zinc, Lead Acid) results in a temperature slope value that becomes less positive, and eventually reaches a minimum value. Further in the charging process, the temperature again starts to increase.

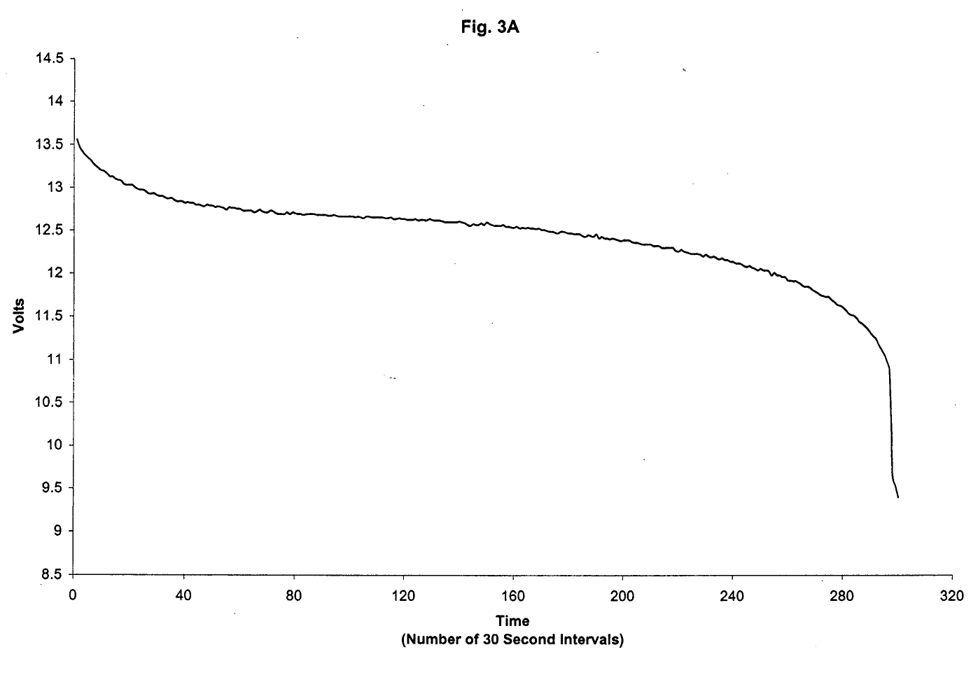

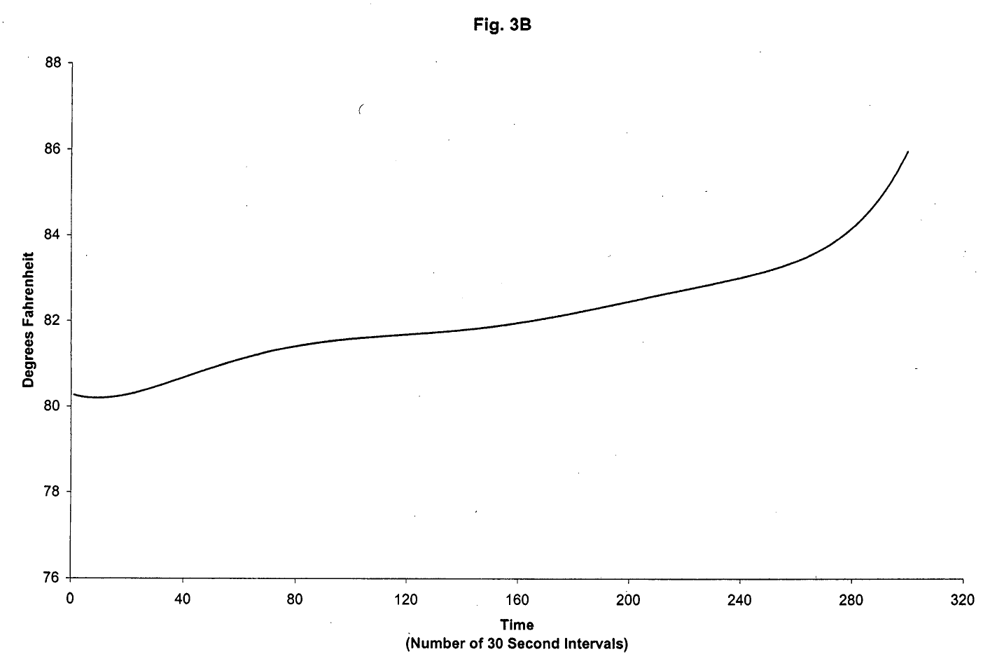

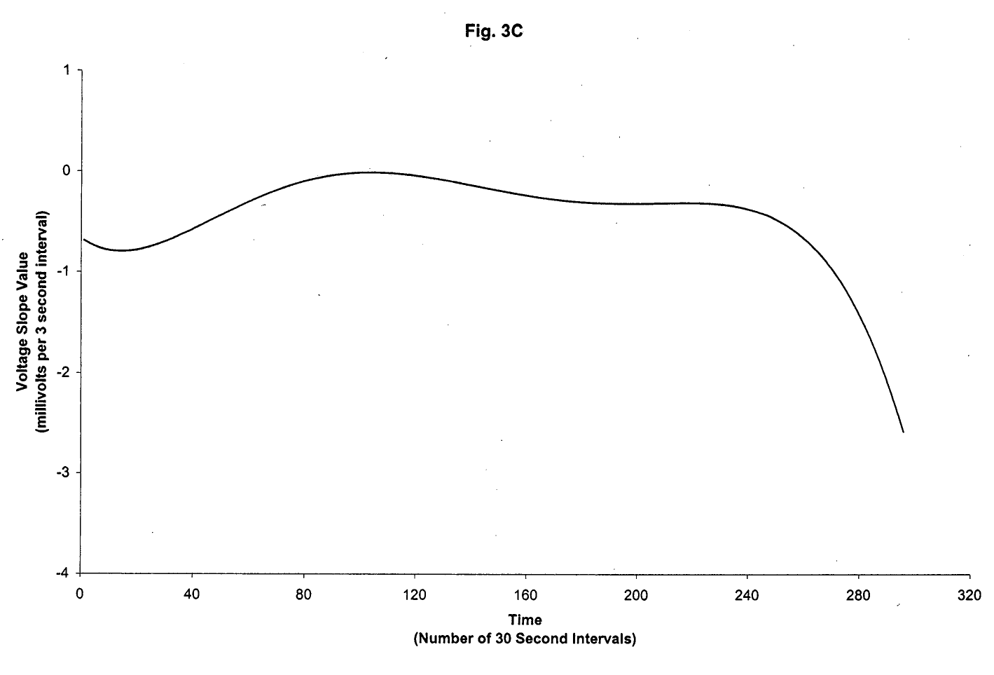

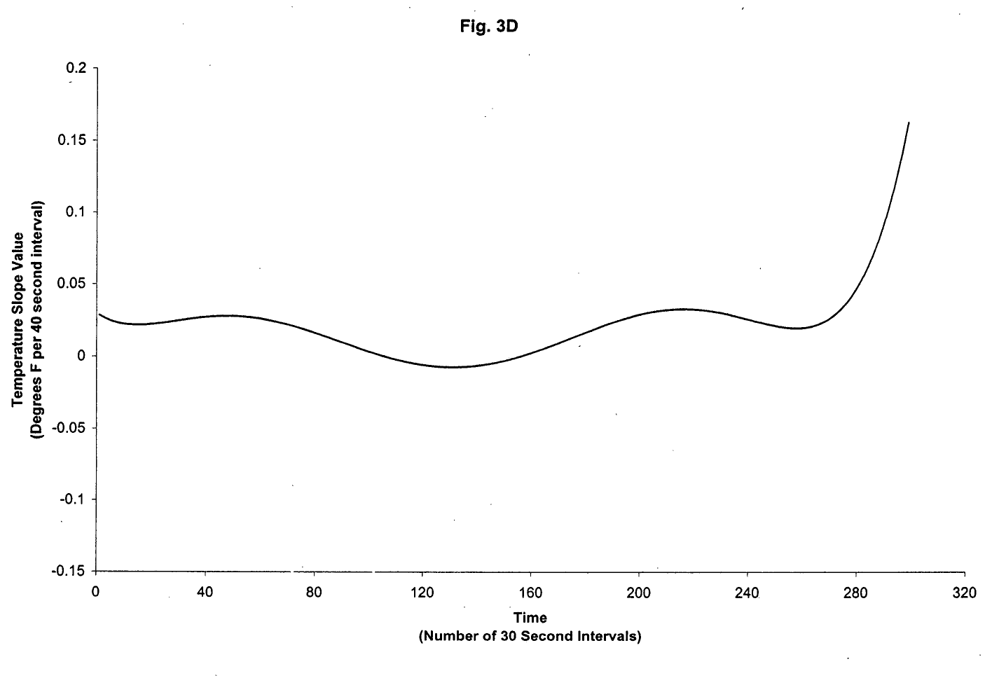

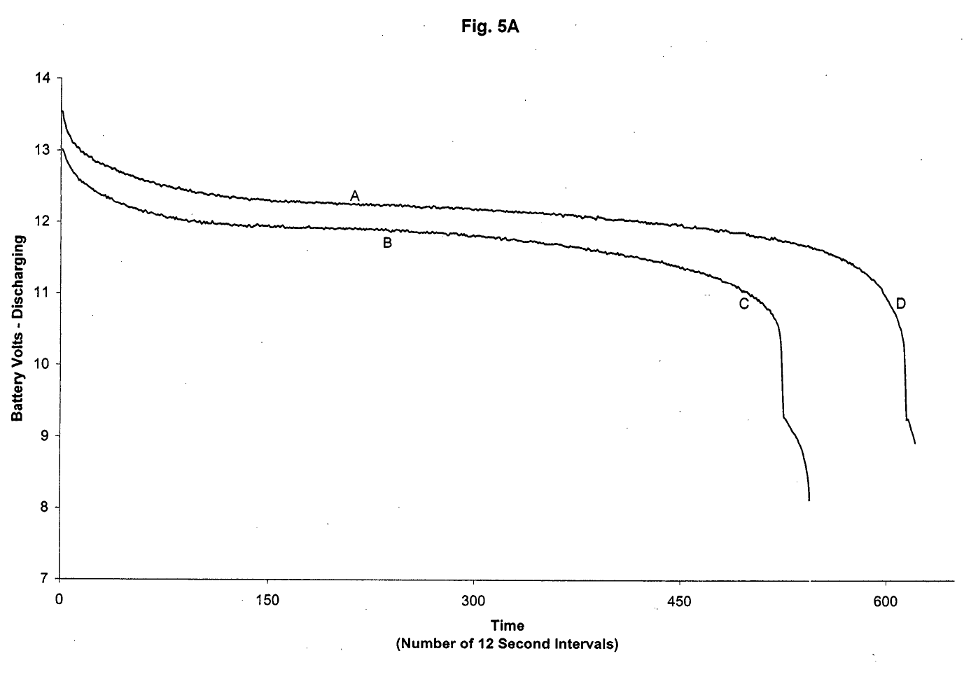

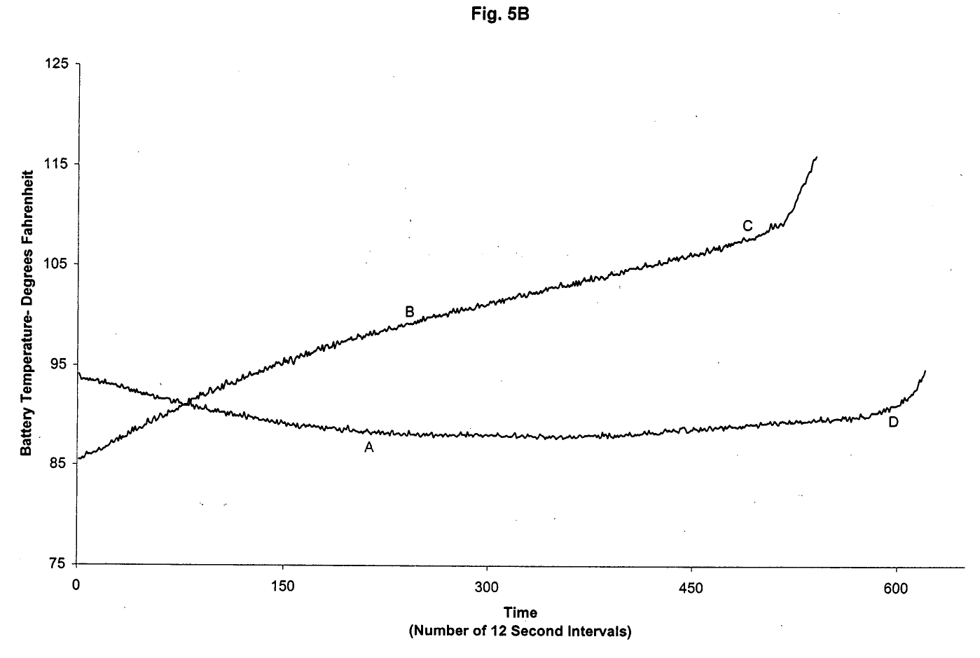

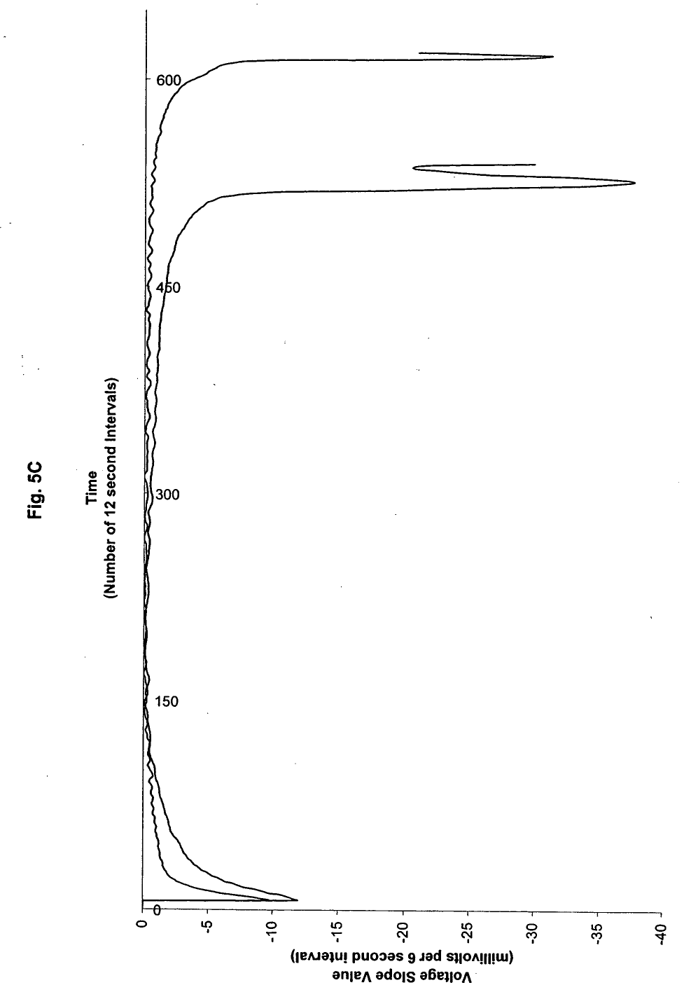

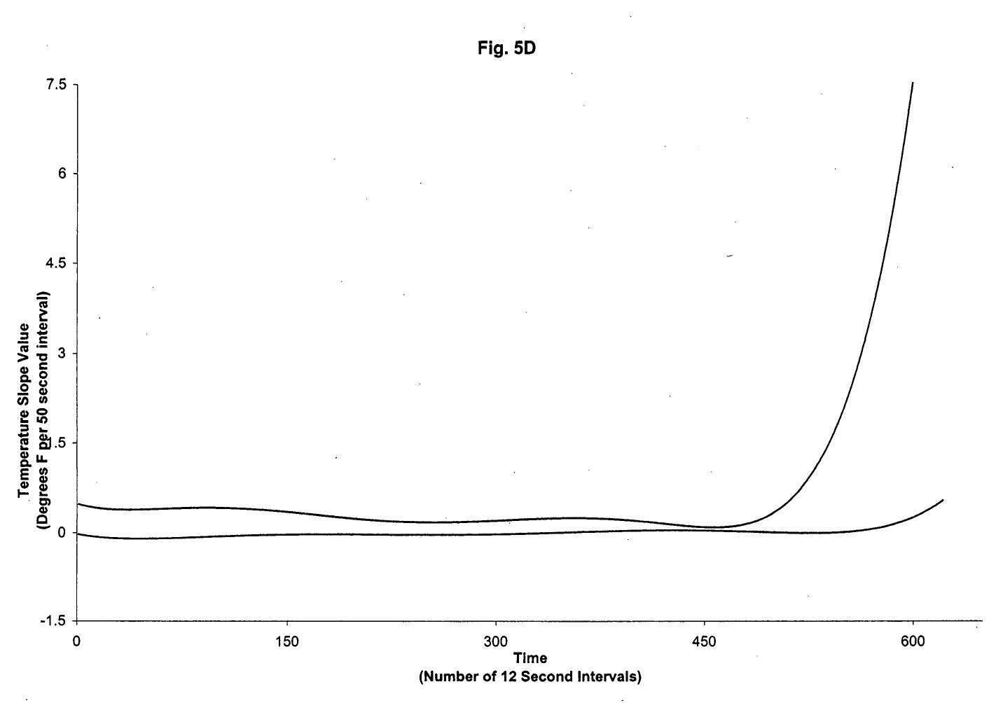

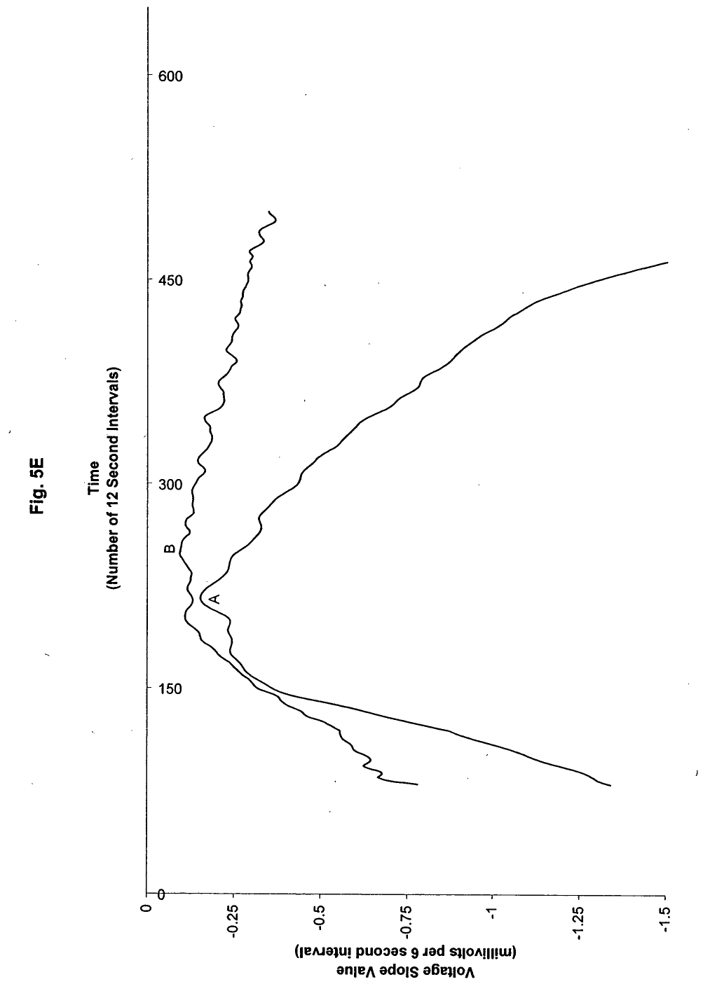

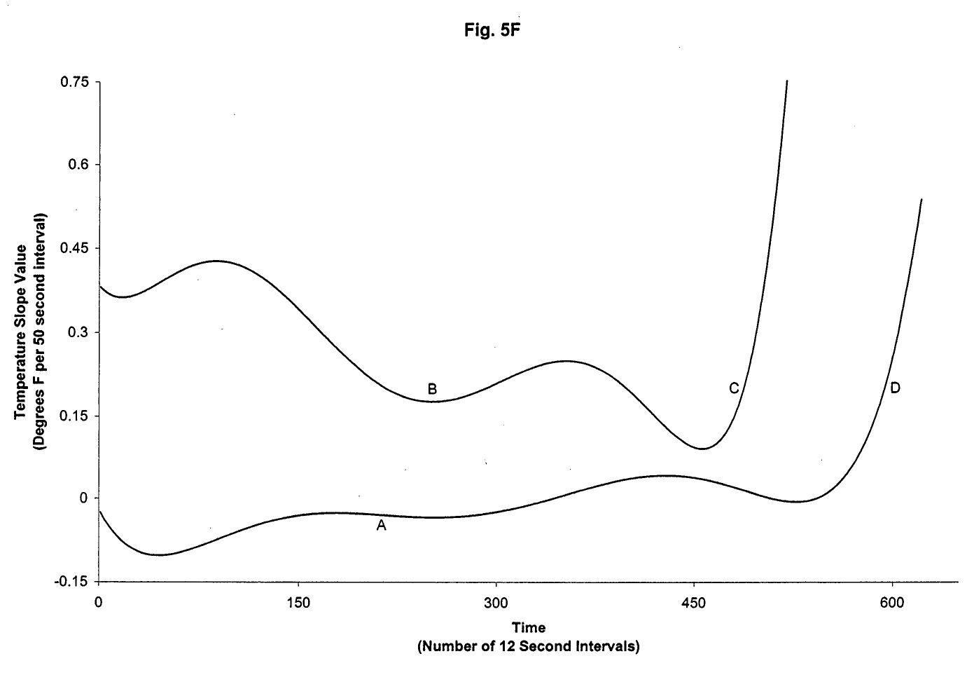

As opposed to the exemplary charging trends illustrated and described above with respect to FIGS. 2A-2D and 4A-4B, FIGS. 3A-3D and 5A-5F relates to exemplary discharging trends. More specifically, FIG. 3A is a graph illustrating an exemplary battery voltage trend during a discharging phase, while FIG. 3C is a graph illustrating a battery voltage slope trend corresponding to the trend illustrated in FIG. 3A. The horizontal axes in FIGS. 3A-3D are expressed in units of time (i.e., time intervals) where each unit equals approximately 30 seconds (in contrast to the 12 second intervals used in FIGS. 1A-1D). More specifically, FIG. 3C represents the derivative of the trend illustrated in FIG. 3A. FIG. 3B is a graph illustrating an exemplary battery temperature trend during a discharging phase, while FIG. 3D is a graph illustrating a battery temperature slope trend corresponding to the trend illustrated in FIG. 3B. More specifically, FIG. 3D represents the derivative of the trend illustrated in FIG. 3B. Although FIGS. 3A-3D are not labeled with points (e.g., points A-H) as are FIGS. 1A-1D, two exemplary health determinations in a discharging process using such points is provided below with respect to FIGS. 5A-5f.

As illustrated in FIG. 3A, as the exemplary battery discharges, the voltage decreases as electrical energy is removed from the battery. The rate at which the voltage decreases with respect to time (e.g., the voltage slope in FIG. 3C) varies depending on, for example, the type of battery, the condition/health of the battery, and the amount of charge in the battery. Changes in the battery slope occur even if a constant resistance load is used to discharge the battery.

As the discharging process progresses, the rate at which the battery voltage decreases in response to the removal of electrical energy results in a voltage slope value that is often less negative as time progresses (See FIG. 3C). Eventually, the battery voltage typically decreases at a minimal rate resulting in a minimum, negative value for voltage slope. As the discharge process progresses even further, the battery voltage decreases at an increased rate resulting in a more negative voltage slope as shown on the right side of FIG. 3C.

The rate at which the temperature of a battery changes with respect to time (e.g., temperature slope) varies during the discharging process depending on, for example, the health/condition of the battery, and the amount of energy in the battery. As illustrated in FIG. 3B, at the initiation of the discharge process, the battery temperature rises slowly in response to the removal of electrical energy. As the discharging process progresses, the rate at which the battery temperature decreases provides temperature slope values that become less positive. At some point in time, the battery temperature slope reaches a minimum value.

According to exemplary embodiments of the present invention, the health of a battery may be determined by comparing one or more actual battery temperature parameter values (e.g., battery temperature magnitude, timing of a battery temperature occurrence, battery temperature slope magnitude, timing of a battery temperature slope occurrence) to corresponding predetermined battery temperature parameter values.

FIGS. 5A through 5F illustrate two examples of the present invention based upon a constant current discharging phase after formation (using 12 second time intervals on the horizontal axes). The exemplary battery used in these examples is a fully formed and charged 3.5 ampere-hour, 10 cell (12V), Nickel Metal Hydride battery. In FIG. 5A, a 1.75 ampere, 2 hour discharge voltage profile is provided for the subject battery, as well as for a predetermined healthy battery. Points A and D are part of the profile of a healthy battery having a predetermined voltage profile, while points B and C represent the discharge profile of the subject battery.

FIG. 5B is a temperature profile of the subject battery (including points B and C) as well as a predetermined profile of a baseline battery (including points A and D). FIG. 5C is a voltage slope profile related to FIG. 5A (the derivative of FIG. 5A), while FIG. 5D is a temperature slope profile related to FIG. 5B (the derivative of FIG. 5B). FIG. 5E is a close up view of a portion of FIG. 5C for use in determining more accurate values of points A and point B. FIG. 5F is a close up of a portion of FIG. 5D.

In the exemplary health determination method provided below, the health of the subject battery is determined by comparing the timing and magnitude of a voltage slope maximum value of a predetermined battery to the timing and magnitude of a voltage slope maximum value of the subject battery.

In this example, a first ratio is calculated by dividing the timing of point A from FIG. 5E (i.e., approximately 217, corresponding to 2604 seconds) on the horizontal axis by the timing of point B from FIG. 5E (i.e., approximately 247, corresponding to 2964 seconds) on the horizontal axis, as provided below:
Ratio 1=217/247=0.8785

Next, a second ratio is calculated using the magnitude of point A from FIG. 5E (i.e., approximately −0.182 on the vertical axis) and the magnitude of point B from FIG. 5E (i.e., approximately −0.091 on the vertical axis), using the following formula:
Ratio 2=[7200+(3300×−0.182)]/[7200+(3300×−0.091)]=6600/6900=0.9565

The health or degree of formation of the subject battery in this example in decimal form (desired=1.000) is the product of the above two ratios:
Health Rating, decimal=0.8785×0.9565=0.840

The health of the subject battery in this example in percent form (desired=100%) is:
Health Rating, percent=0.8785×0.9565×100%=84.0%

Referring now to FIG. 5F, another exemplary health determination is provided herein. In this example, the timing and magnitude of a second temperature slope minimum for a predetermined formed battery (See point A on FIG. 5F) is compared to the timing and magnitude of an actual second temperature slope minimum (point B) of the subject battery. As described above, FIG. 5F is a close up of a portion of FIG. 5D for use in determining accurate values of points A and point B.

In this second example, the first ratio is the same as the first ratio above (i.e., Ratio 1=217/247=0.8785) because the voltage slope maximum values (i.e., points A and B on FIG. 5E) coincide with the temperature slope minimum values (i.e., points A and B on FIG. 5F).

In this second example, a second ratio relates to the occurrence of the second temperature slope minimums illustrated in FIG. 5F. More specifically, FIG. 5F illustrates the second predetermined temperature slope minimum at point A (i.e., −0.030 on the vertical axis) and the second actual temperature slope minimum at point B (i.e., 0.180 on the vertical axis). These values are used in the following formula related to the second ratio:
Ratio 2=[7200−(1600×0.18)]/[7200−(1600×−0.03]=6912/7248=0.9536

The health of the subject battery using the second temperature slope minimums in this example expressed in decimal form (desired=1.000) is the product of the above two ratios:
Health Rating, decimal=0.8785×0.9536=0.8378

The health of the subject battery in this example in percent form (desired=100%) is:
Health Rating, percent=0.8785×0.9536×100%=83.78%

In the two examples described above with respect to FIGS. 5A-F, 7200 was used as a predetermined factor for the post formation discharge process, and this number (i.e., 7200) is the number of seconds in 2 hours, which is an exemplary time period used to completely discharge a fully formed and charged healthy battery. In the first example, the 3300 factor is a factor determined to be useful for discharge periods on the order of 2 hours, where voltage slope maximums are used to determine the battery health. Similarly, in the second example, the 1600 factor is a factor determined to be useful for discharge periods on the order of 2 hours, where temperature slope minimums are used to determine the battery health. These factors are only exemplary in nature, and various factors may be used in accordance with the present invention. Establishing such predetermined factors may involve, for example, using initial battery voltage measurements, initial battery temperature measurements, and initial and subsequent battery ambient temperatures.

The examples described above with respect to FIGS. 5A-5F relate to determining the health of a newly formed battery in a discharge phase. As provided above, certain exemplary embodiments of the present invention determine the health of a battery using a single parameter value. With respect to FIGS. 5E-5F, a single voltage maximum value (e.g., point B on FIG. 5E) or a single temperature minimum (e.g., point B on FIG. 5F) may be used to determine the health of a battery. Since point B in FIGS. 5E-5F occurs at approximately 247 time cycles (i.e., 247 twelve second intervals), the health determination may be completed in less than half the time used to fully discharge the battery.

In accordance with certain exemplary embodiments of the present invention, a certain threshold health rating may be established below which a battery is deemed to be defective, and therefore should be replaced. If the battery health rating is a percentage value, then a percentage value may be established for the threshold health rating. For example, a health rating of 80% may indicate that a battery is defective and should be replaced.

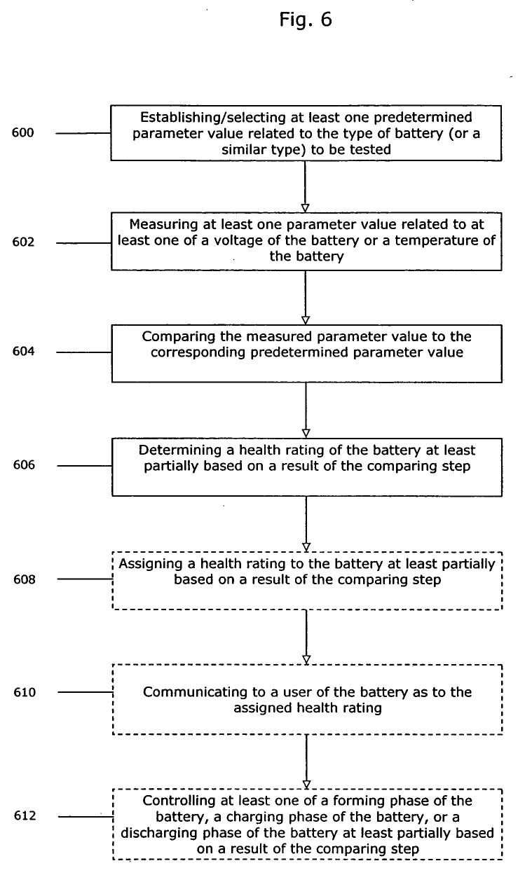

FIG. 6 is a flow diagram illustrating a method of determining the health of a battery. At step 600, at least one predetermined parameter value related to the type of battery to be tested (or a similar type of battery) is established or selected. For example, if the health of a type A battery is to be determined, then a predetermined parameter value should be established for a type A battery or a similar type of battery. At step 602, at least one parameter value related to at least one of a voltage of the battery or a temperature of the battery is measured. At step 604, the measured parameter value (i.e., of the subject battery) is compared to a corresponding predetermined parameter value. At step 606, the health of the battery is determined at least partially based on the comparison of step 604. At optional step 608, a health rating is assigned to the battery at least partially based on a result of the comparison at step 604. At optional step 610, the assigned health rating is communicated to a user of the battery. At optional step 612, at least one of a forming phase of the battery, a charging phase of the battery, or a discharging phase of the battery is controlled at least partially based on a result of the comparison at step 604.

Although the present invention has primarily been described as a method of determining the health of a battery, it is contemplated that the invention could be implemented entirely (or in part) in software on a computer readable carrier such as a magnetic or optical storage medium, or an auto frequency carrier or a radio frequency carrier.

The present invention may be embedded into an electronic device, for example, portable consumer products, power tools, audio/video products, communications products, remote control toys, cellular and cordless telephones, PDAs, portable PCs, portable instruments, and other wireless products.

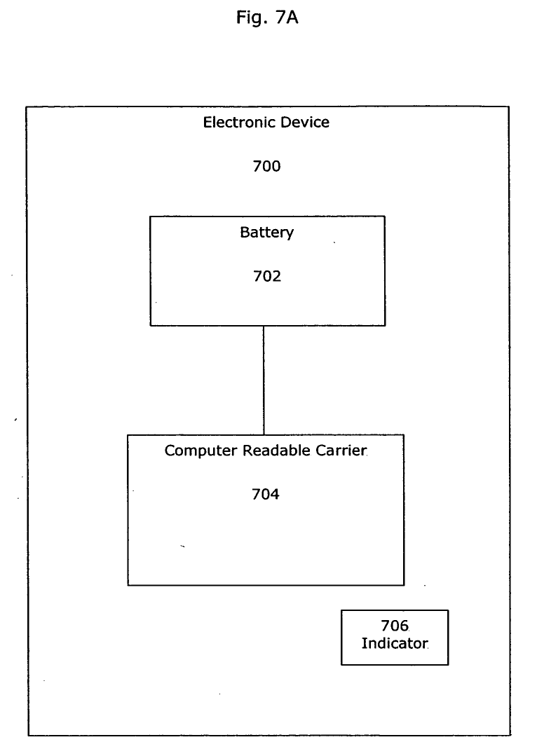

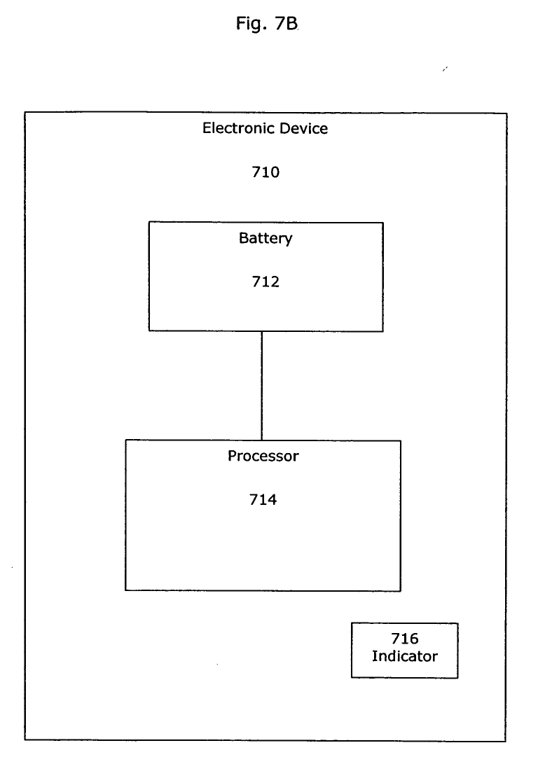

FIG. 7A is a block diagram of electronic device 700. Electronic device 700 includes battery 702 and computer readable carrier 704. In this exemplary embodiment, battery 702 provides DC power to at least a portion of electronic device 700. Computer readable carrier 704 includes computer program instructions for implementing the battery charging methods disclosed herein. As described above, electronic device 700 may be a portable computer, a PDA, a portable telephone, a radio, or any of a number of powered devices configured for use with a rechargeable battery. Further, while electronic device 700 is illustrated as a single unit housing battery 702 and computer readable carrier 704, it is not limited thereto. For example, electronic device 700 may include a portable device (e.g., a cordless telephone handset) and a charging device (e.g., a charging stand for the handset). In such an embodiment, battery 702 would be provided in the cordless telephone handset; however, computer readable carrier 704 may be provided in the handset or in the separate charging stand.

Electronic device 700 also includes indicator 706. Indicator 706 may be used, for example, to communicate a health rating of battery 702 to a user of electronic device 700. For example, indicator 706 may be a display (e.g., a digital display) for displaying the health rating (e.g., in decimal form, percent form, etc.), or may be an audible indicator for communicating the health rating to a user of electronic device 700.

FIG. 7B is a block diagram of electronic device 710. Electronic device 710 includes battery 712 and processor 714. Processor 714 receives a measurement of at least one parameter value related to at least one of a voltage of the battery or a temperature of the battery. The processor compares the measurement of the parameter value received by the processor to a corresponding predetermined parameter value to determine the health of the battery. As described above with respect to FIG. 7A, electronic device 710 may include a portable device (e.g., a cordless telephone handset) and a charging device (e.g., a charging stand for the handset). In such an embodiment, battery 712 would be provided in the cordless telephone handset; however, processor 714 may be provided in the handset or in the separate charging stand.

Processor 714 may be provided as an independent processor for carrying out operations of the present invention. In an alternative embodiment, processor 714 may also be a processor included in electronic device 710 for carrying out multiple functions, at least one of which does not directly relate to the present invention. For example, processor 714 may carry out functions related to a charging algorithm for charging the battery, as well as functions related to the present invention.

Electronic device 710 also includes indicator 716. Indicator 716 may be used, for example, to communicate a health rating of battery 712 to a user of electronic device 710. For example, indicator 716 may be a display (e.g., a digital display) for displaying the health rating (e.g., in decimal form, percent form, etc.), or may be an audible indicator for communicating the health rating to a user of electronic device 710.

Thus, the battery health determination methods disclosed herein may be implemented in a number of applications, for example, in a factory formation (charging/discharging) system, in a battery charger (e.g., a bench-top charger, a desk-top charger, a cellular phone charge, a cordless phone charger), in products utilizing internal charging, and in a battery pack itself. Further, the battery health determination algorithm could be implemented in an existing controller. For example, the battery health determination methods could be implanted as an algorithm that is run on a PC or in a cell phone, for example

U.S. Pat. No. 5,600,226 discloses various features related to formation, charging, and discharging methods that may be used in conjunction with the present invention. For example, U.S. Pat. No. 5,600,226 discloses pulsing energy, which may be applied to formation in order to reduce formation time (e.g., reducing formation times by 60%), while substantially reducing energy consumption by (e.g., reducing energy consumption by 40%). The pulsing techniques disclosed in U.S. Pat. No. 5,600,226 may also be used to reduce charging times (e.g., reducing charging times by up to 15%), while substantially reducing energy consumption (e.g., reducing energy consumption by up to 10%). Of course, these are simply examples of formation and charging techniques and the present invention is not limited thereto.

U.S. Pat. No. 5,600,226 also discloses voltage sampling, and slope value calculation and storage techniques which may be used in conjunction with the present invention, for example, during any of formation, a charging phase, and a discharging phase. Further, the present invention may be implemented in any formation, charging, or discharging process. For example, U.S. Pat. No. 5,600,226 discloses certain formation and charging techniques that may be used in conjunction with the present invention. One such technique relates to gradually increasing energy input into a battery at the beginning of a formation and/or charging process. Another such technique relates to applying a discharge pulse in between input energy pulses during formation and charge processes.

U.S. Pat. No. 5,600,226 also discloses acquiring battery data (e.g., battery voltage data) with no current flowing into or out of the battery. For example, this may be accomplished by sampling for the desired data in between input energy pulses during the formation and/or charging processes. When used in conjunction with the present invention, this technique allows for the measurement of voltage and/or temperature parameter values with reduced electrical noise and offset effects because there is no current flowing through series resistances internal to and external the battery, wires, connectors, etc.

The battery health determination techniques disclosed herein may be carried out during a number of battery operations, for example, during (a) battery formation, (b) a charging phase, and/or (c) a discharging phase. If the health determination related measurements are performed during formation, the formation process may be a complete formation or a partial formation. Likewise, if the health determination related measurements are performed during a charging or discharging process, such a process may be a complete charging/discharging process or a partial charging/discharging process.

According to certain exemplary embodiments of the present invention, an indication is provided to a user of the battery regarding the health of a battery, for example, through a battery health rating. Such a health rating may be expressed using any of a number of configurations, for example, in decimal form, in percent form, as a portion of a visual indication (e.g., a portion of a “pie” corresponding to the percent health), etc. The indication may be physically embodied in a display that is part of an electronic device, a computer used in conjunction with the health determination, etc.

According to certain exemplary embodiments of the present invention, certain battery operations (e.g., formation, charging, and discharging operations) may be at least partially controlled based on the health determination techniques disclosed herein. For example, the electrical energy applied to a battery during formation or charging may be dynamically adjusted based on the health of the battery. More specifically, the duration of an input energy pulse applied during formation or charging may be adjusted and/or modulated based on the health of the battery. Likewise, the duration of discharge pulses applied between input energy pulses during formation and/or charging may be adjusted and/or modulated. Further, any battery operation (e.g., formation, charging, or discharging) may be continued, monitored, terminated, or otherwise varied at least partially based on the health determination.

Although the present invention has primarily been described with respect to determining the health of a battery a single time, it is not limited thereto. For example, the health of a battery may be determined using the present invention at predetermined intervals, continuously, or as desired.

Although the invention is illustrated and described herein with reference to specific embodiments, the invention is not intended to be limited to the details shown. Rather, various modifications may be made in the details within the scope and range of equivalents of the claims and without departing from the invention.

1. A method of determining the health of a battery comprising the steps of:
measuring at least one parameter value related to at least one of a voltage of the battery or a temperature of the battery;
comparing the measured parameter value to a corresponding predetermined parameter value; and
determining the health of the battery at least partially based on a result of the comparing step.

2. The method of claim 1 comprising the additional step of:
assigning a health rating to the battery at least partially based on a result of the comparing step.

3. The method of claim 2 comprising the additional step of:
communicating the assigned health rating to a user.

4. The method of claim 1 comprising the additional step of:
controlling at least one of a forming phase of the battery, a charging phase of the battery, or a discharging phase of the battery at least partially based on a result of the comparing step.

5. The method of claim 1 wherein the measuring step occurs during at least one of a forming phase of the battery, a charging phase of the battery, or a discharging phase of the battery.

6. The method of claim 1 wherein the step of measuring at least one parameter value includes measuring at least one of a time or a magnitude of at least one voltage slope value of the battery.

7. The method of claim 1 wherein the step of measuring at least one parameter value includes measuring at least one of a time or a magnitude of at least one minimum voltage slope value of the battery.

8. The method of claim 7 wherein the step of comparing includes comparing the at least one of a time or a magnitude of at least one minimum voltage slope value of the battery to a corresponding predetermined time or magnitude value.

9. The method of claim 1 wherein the step of measuring at least one parameter value includes measuring at least one of a time or a magnitude of at least one temperature slope value of the battery.

10. The method of claim 1 wherein the step of measuring at least one parameter value includes measuring at least one of a time or a magnitude of at least one minimum temperature slope value of the battery.

11. The method of claim 10 wherein the step of comparing includes comparing the at least one of a time or a magnitude of at least one minimum temperature slope value of the battery to a corresponding predetermined time or magnitude value.

12. The method of claim 1 wherein the step of measuring occurs when the battery is substantially neither charging nor discharging.

13. The method of claim 1 wherein the predetermined parameter value is predetermined based at least partially upon the type of the battery.

14. A method of determining the health of a battery comprising the steps of:
measuring, during at least one of a forming phase of the battery, a charging phase of the battery, or a discharging phase of the battery, at least one parameter value related to at least one of (a) at least one of a time or a magnitude of at least one minimum voltage slope value of the battery, and (b) at least one of a time or a magnitude of at least one minimum temperature slope value of the battery;
comparing the measured parameter value to a corresponding predetermined parameter value; and
determining the health of the battery at least partially based on a result of the comparing step.

15. A computer readable carrier including computer program instructions for implementing a method of determining the health of a battery, the method comprising the steps of:
measuring at least one parameter value related to at least one of a voltage of the battery or a temperature of the battery;
comparing the measured parameter value to a corresponding predetermined parameter value; and
determining the health of the battery at least partially based on a result of the comparing step.

16. The computer reader carrier of claim 15 wherein the method comprises the additional step of controlling at least one of a forming phase of the battery, a charging phase of the battery, or a discharging phase of the battery at least partially based on a result of the comparing step.

17. The computer reader carrier of claim 15 wherein the measuring step occurs during at least one of a forming phase of the battery, a charging phase of the battery, or a discharging phase of the battery.

18. The computer reader carrier of claim 15 wherein the step of measuring at least one parameter value includes measuring at least one of a time or a magnitude of at least one voltage slope value of the battery.

19. The computer reader carrier of claim 15 wherein the step of measuring at least one parameter value includes measuring at least one of a time or a magnitude of at least one minimum voltage slope value of the battery.

20. The computer reader carrier of claim 15 wherein the step of measuring at least one parameter value includes measuring at least one of a time or a magnitude of at least one temperature slope value of the battery.

21. The computer reader carrier of claim 15 wherein the step of measuring at least one parameter value includes measuring at least one of a time or a magnitude of at least one minimum temperature slope value of the battery.

22. The computer reader carrier of claim 15 wherein the step of measuring occurs when the battery is substantially neither charging nor discharging.

23. An electronic device comprising:
a battery providing DC power to at least a portion of the electronic device; and
a computer readable carrier including computer program instructions for implementing a method of determining the health of the battery, the method comprising the steps of:
measuring at least one parameter value related to at least one of a voltage of the battery or a temperature of the battery;
comparing the measured parameter value to a corresponding predetermined parameter value, the predetermined parameter value being related to a similar or identical type of battery as the battery; and
determining the health of the battery at least partially based on a result of the comparing step.

24. The electronic device of claim 23 wherein the method comprises the additional step of controlling at least one of a forming phase of the battery, a charging phase of the battery, or a discharging phase of the battery at least partially based on a result of the comparing step.

25. The electronic device of claim 23 wherein the measuring step occurs during at least one of a forming phase of the battery, a charging phase of the battery, or a discharging phase of the battery.

26. The electronic device of claim 23 wherein the step of measuring at least one parameter value includes measuring at least one of a time or a magnitude of at least one voltage slope value of the battery.

27. The electronic device of claim 23 wherein the step of measuring at least one parameter value includes measuring at least one of a time or a magnitude of at least one minimum voltage slope value of the battery.

28. The electronic device of claim 23 wherein the step of measuring at least one parameter value includes measuring at least one of a time or a magnitude of at least one temperature slope value of the battery.

29. The electronic device of claim 23 wherein the step of measuring at least one parameter value includes measuring at least one of a time or a magnitude of at least one minimum temperature slope value of the battery.

30. The electronic device of claim 23 wherein the step of measuring occurs when the battery is substantially neither charging nor discharging.

31. An electronic device comprising:
a battery providing DC power to at least a portion of the electronic device; and
a processor,
the processor receiving a measurement of at least one parameter value related to at least one of a voltage of the battery or a temperature of the battery,
the processor comparing the received measurement of the parameter value to a corresponding predetermined parameter value to determine the health of the battery.

32. The electronic device of claim 31 wherein the processor controls at least one of a forming phase of the battery, a charging phase of the battery, or a discharging phase of the battery at least partially based on a result of the comparison of the measured parameter value to the corresponding predetermined parameter value.

33. The electronic device of claim 31 wherein the measurement of the at least one parameter value occurs during at least one of a forming phase of the battery, a charging phase of the battery, or a discharging phase of the battery.

34. The electronic device of claim 31 wherein the measurement of the at least one parameter value includes a measurement of at least one of a time or a magnitude of at least one voltage slope value of the battery.

35. The electronic device of claim 31 wherein the measurement of the at least one parameter value includes a measurement of at least one of a time or a magnitude of at least one minimum voltage slope value of the battery.

36. The electronic device of claim 31 wherein the measurement of the at least one parameter value includes a measurement of at least one of a time or a magnitude of at least one temperature slope value of the battery.

37. The electronic device of claim 31 wherein the measurement of the at least one parameter value includes a measurement of at least one of a time or a magnitude of at least one minimum temperature slope value of the battery.

38. The electronic device of claim 31 wherein the measurement of the at least one parameter value occurs when the battery is substantially neither charging nor discharging.

39. An electronic device for charging or monitoring a battery comprising:
a power supply providing DC power to at least a portion of the electronic device; and
a processor,
the processor receiving a measurement of at least one parameter value related to at least one of a voltage of the battery or a temperature of the battery,
the processor comparing the received measurement of the parameter value to a corresponding predetermined parameter value to determine the health of the battery.

40. The electronic device of claim 31 wherein the electronic device is for monitoring the battery and the power supply is the battery.
